(19) United States
(12) Patent Application Publication
(10) Pub. No.: US 2025/0203597 A1
(43) Pub. Date: Jun. 19, 2025

(54) METHODS, COMMUNICATIONS DEVICES, AND NETWORK INFRASTRUCTURE EQUIPMENT

(71) Applicant: Sony Group Corporation, Tokyo (JP)

(72) Inventors: Shin Horng WONG, Chippenham (GB); Basuki PRIYANTO, Lund (SE); Anders BERGGREN, Lund (SE)

(73) Assignee: Sony Group Corporation, Tokyo (JP)

(21) Appl. No.: 18/845,902

(22) PCT Filed: Mar. 9, 2023
(86) PCT No.: PCT/EP2023/055997

§ 371 Date: Sep. 11, 2024

(30) Foreign Application Priority Data
Mar. 29, 2022 (EP) 22165239.9

(51) Int. Cl. H04W 72/11; H04W 72/23

(52) U.S. Cl. CPC H04W 72/11; H04W 72/23

(57) ABSTRACT

Methods and apparatus for updating parameters for scheduled downlink transmissions. A method for an infrastructure equipment, includes transmitting, to a communications device, an activation message (e.g. an activation DCI), wherein the activation message configures the communications device to monitor a plurality of periodic scheduling windows (e.g. an plurality of SRS occasions) for downlink transmissions (e.g. a PDSCH), wherein the activation message indicates an initial set of parameters for the down-link transmissions (e.g. a transport block size). The method includes transmitting, to the communications device, an update message, wherein the update message indicates an updated set of parameters for one or more of the downlink transmissions and transmitting, to the communications device and during a scheduling window of the plurality of periodic scheduling windows, a downlink transmission according to the updated set of parameters.

The present application claims the Paris Convention priority of European patent application EP22165239.9, filed 29 Mar. 2022, the contents of which are hereby incorporated by reference

### Background

### Field of Disclosure

The present disclosure relates to a communications device, network infrastructure equipment and methods of operating a communications device to receive data from a wireless communications network.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Latest generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Current generation wireless communications networks are expected to routinely and efficiently support communications with an ever-increasing range of devices associated with a wide range of data traffic profiles and types. For example, wireless communications networks are expected efficiently to support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is a desire for current generation wireless communications networks, for example those referred to as 5G or new radio (NR) systems/new radio access technology (RAT) systems, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is enhanced Mobile Broadband (eMBB) services, which are characterised by a high capacity with a requirement to support up to 20 Gb/s. URLLC and eMBB type services therefore represent challenging examples for both LTE type communications systems and 5G/NR communications systems.

5G NR has continuously evolved and the current agenda includes 5G-NR-advanced in which some further enhancements are expected, especially to support new use-cases/scenarios with higher requirements. The increasing use of different types of network infrastructure equipment and terminal devices associated with different traffic profiles give rise to new challenges for efficiently handling communications in wireless communications systems that need to be addressed.

### SUMMARY OF THE DISCLOSURE

The present disclosure can help address or mitigate at least some of the issues discussed above.

According to a first aspect there is provided a method for an infrastructure equipment, the method comprising: transmitting, to a communications device, an activation message, wherein the activation message configures the communications device to monitor a plurality of periodic scheduling windows for downlink transmissions, wherein the activation message indicates an initial set of parameters for the downlink transmissions; transmitting, to the communications device, an update message, wherein the update message indicates an updated set of parameters for one or more of the downlink transmissions; and transmitting, to the communications device and during a scheduling window of the plurality of periodic scheduling windows, a downlink transmission according to the updated set of parameters.

According to a second aspect there is provided a method for a communications device, the method comprising: receiving, from an infrastructure equipment, an activation message, wherein the activation message configures the communications device to monitor a plurality of periodic scheduling windows for downlink transmissions, wherein the activation message indicates an initial set of parameters for the downlink transmissions; receiving, from the infrastructure equipment, an update message, wherein the update message indicates an updated set of parameters for one or more of the downlink transmissions; monitoring, a scheduling window of the plurality of periodic scheduling windows; and receiving, from the infrastructure equipment and during the scheduling window, a downlink transmission according to the updated set of parameters.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 is an illustrative representation of communications resources in time and frequency for uplink and downlink channels of a time divided wireless access interface in which multiple Hybrid Automatic Repeat Request Acknowledgements (HARQ-ACK) may be multiplexed onto a single Physical Uplink Control Channel (PUCCH);

FIG. 5 is an illustrative representation of communications resources in time and frequency for uplink and downlink channels of a time divided wireless access interface in which a PUCCH Resource Indicator is used to indicate onto which PUCCH HARQ-ACKs may be multiplexed;

FIG. 6 is an illustrative representation of communications resources in time and frequency for uplink and downlink channels of a time divided wireless access interface in which an example of sub-slot based PUCCH is shown;

FIG. 7 is an illustrative representation of communications resources in time and frequency for uplink and downlink channels of a time divided wireless access interface in which multiple HARQ-ACKs for Semi-Persistent Scheduling (SPS) Physical Downlink Shared Channels (PDSCHs) are be multiplexed onto a single PUCCH per sub-slot;

FIG. 8 is an illustrative example of non-integer packet periodicity.

FIG. 9 is an illustrative example of variability in packet size and timing of particular traffic.

FIG. 10 is an illustrative example of jitter in packet arrival.

FIG. 11 is an illustrative example of a technique for accounting for jitter in packet arrival.

FIG. 12 is an illustrative example of variable packet size for periodic traffic.

FIG. 13 is an illustrative example of a technique for accounting for variable packet size for periodic traffic.

FIG. 14 is an illustrative example of a technique for accounting for variable packet size for periodic traffic.

FIG. 15 illustrates an example technique according to the present disclosure for transmitting an update DCI message.

FIG. 16A is an illustrative example of an update DCI.

FIG. 16B is an illustrative example of an update DCI

FIG. 16C is an illustrative example of an update DCI FIG. 16D is an illustrative example of an update DCI

FIG. 17A is an illustrative example of use of an update DCI to provide additional information regarding a PDSCH.

FIG. 17B is an illustrative example of use of an update DCI to provide additional information regarding a PDSCH.

FIG. 17C is an illustrative example of use of an update DCI to provide additional information regarding a PDSCH.

FIG. 18 illustrates an example technique according to the present disclosure for transmitting an update DCI message.

FIG. 19 is an illustrative example of the timing of transmission of an update DCI message.

FIG. 20A is an illustrative example of use of an update DCI message to temporarily alter PDSCH parameters.

FIG. 20B is an illustrative example of use of an update DCI message to temporarily alter PDSCH parameters.

FIG. 21 is an illustrative example of use of an update DCI message to modify the timing of an SPS occasion.

FIG. 22 illustrates an example technique according to the present disclosure for transmitting an update DCI message.

FIG. 23 illustrates a flow diagram of an example method for an infrastructure equipment according to the present disclosure.

FIG. 24 illustrates a flow diagram of an example method for a communications device according to the present disclosure.

### DETAILED DESCRIPTION OF THE EMBODIMENTS

### Long Term Evolution Advanced Radio Access Technology (4G)

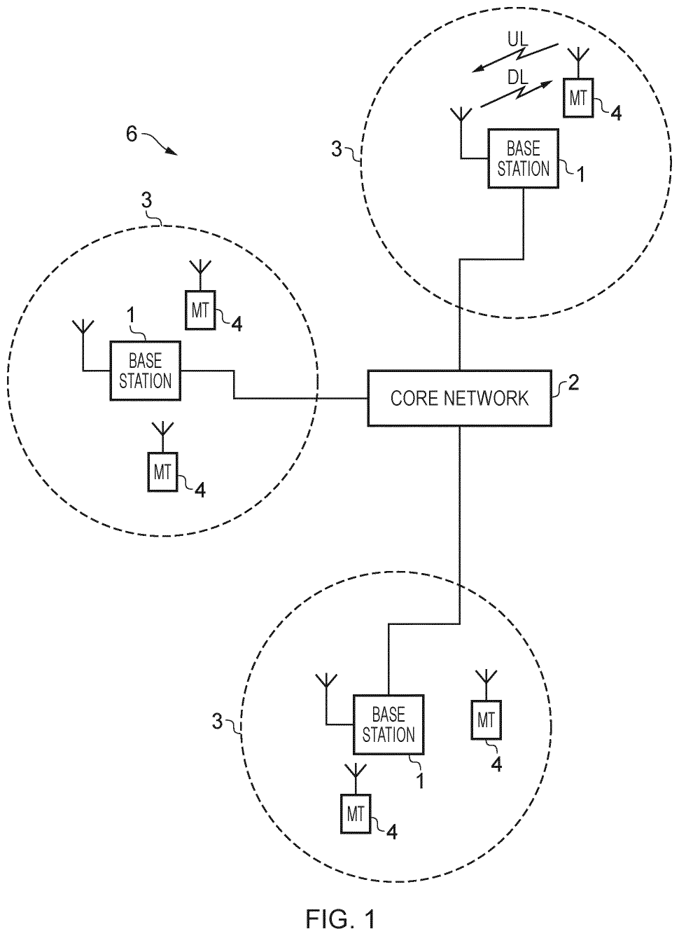

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP® body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices or mobile terminals (MT) 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. The communications or terminal devices 4 may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G (NR))

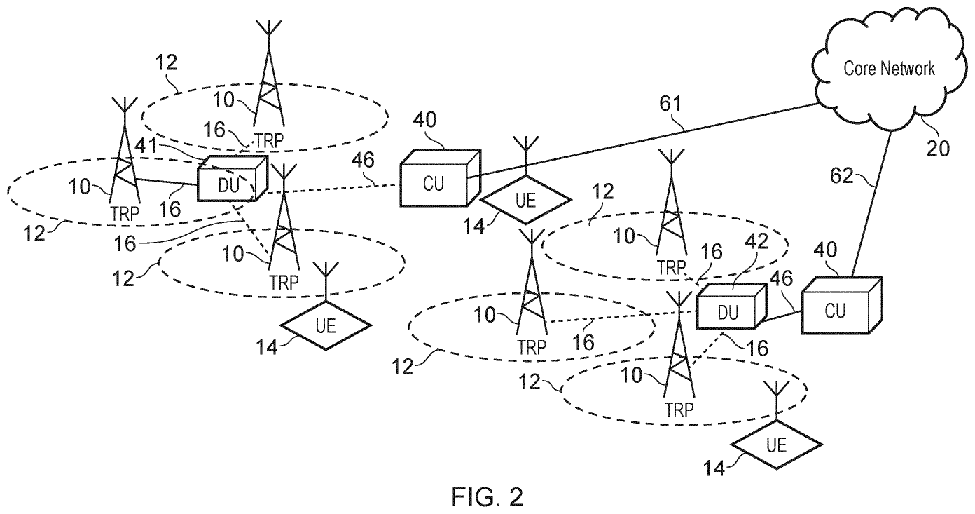

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

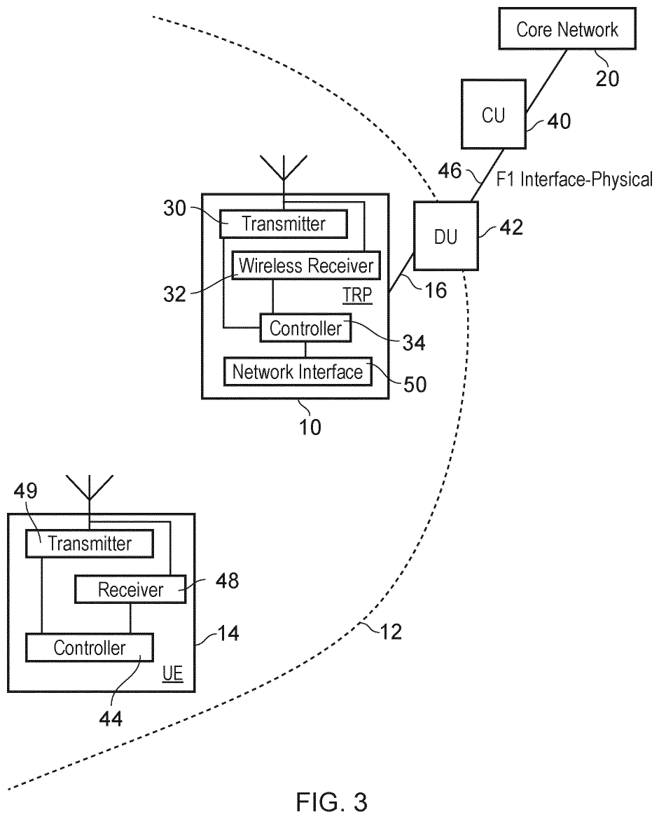

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter circuit 49, a receiver circuit 48 and a controller circuit 44 which is configured to control the transmitter circuit 49 and the receiver circuit 48 to transmit signals representing uplink data to the wireless communications network via the wireless access interface formed by the TRP 10 and to receive downlink data as signals transmitted by the transmitter circuit 30 and received by the receiver circuit 48 in accordance with the conventional operation.

The transmitter circuits 30, 49 and the receiver circuits 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controller circuits 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory.

The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

eURLLC and eMBB

Systems incorporating NR technology are expected to support different services (or types of services), which may be characterised by different requirements for latency, data rate and/or reliability. For example, Enhanced Mobile Broadband (eMBB) services are characterised by high capacity with a requirement to support up to 20 Gb/s. The requirements for Ultra Reliable and Low Latency Communications (URLLC) services are for one transmission of a 32 byte packet to be transmitted from the radio protocol layer 2/3 SDU ingress point to the radio protocol layer 2/3 SDU egress point of the radio interface within 1 ms with a reliability of 1-10⁻⁵ (99.999%) or higher (99.9999%) [2].

Massive Machine Type Communications (mMTC) is another example of a service which may be supported by NR-based communications networks. In addition, systems may be expected to support further enhancements related to Industrial Internet of Things (IIoT) in order to support services with new requirements of high availability, high reliability, low latency, and in some cases, high-accuracy positioning.

Enhanced URLLC (eURLLC) [3] specifies features that require high reliability and low latency, such as factory automation, transport industry, electrical power distribution, etc. in a 5G system. eURLLC is further enhanced as IIoT-URLLC [4], for which the objectives are to enhance UE feedback for Hybrid Automatic Repeat Request Acknowledgements (HARQ-ACK) signalling for downlink transmissions (for example, PDSCH), increase signalling bits for sub-band CQI, URLCC operations in unlicensed band and intra-UE UCI multiplexing of different L1 priorities.

### PDSCH HARQ-ACK/NACK Signalling

In general, as will be appreciated, Hybrid Automatic Repeat Request (HARQ) feedback is transmitted by a communications device (UE) to an infrastructure equipment (such as a gNB) in respect of a scheduled physical downlink shared channel (PDSCH) to inform the infrastructure equipment whether or not the communications device has successfully decoded the corresponding PDSCH. Each PDSCH may be transmitted according to a different HARQ process which may be assigned a particular HARQ Process Number (HPN) to identify the HARQ process for that PDSCH. The HPN number may be assigned by infrastructure equipment in the wireless communications network, such as a gNB. Each HARQ process involves transmitting a HARQ acknowledgment (i.e. an ACK) or a HARQ negative acknowledgment (i.e. a NACK) depending on whether the PDSCH transmitted according to that HARQ process was successfully received/decoded. For example, if the PDSCH was successfully received/decoded, the receiving communications device will send a HARQ acknowledgment (i.e. an ACK), and if the transmission was not successfully received the communications device will send a HARQ negative acknowledgment (i.e. a NACK).

It will be appreciated by one skilled in the art that references to “HARQ-ACK” can represent either an “ACK” or a “NACK”, and is therefore used when it is not necessary to distinguish between an “ACK” and a “NACK”.

For scheduled transmission of downlink data from an infrastructure equipment to a communications device in a wireless communications network, it is common for the infrastructure equipment to first send control signalling, e.g. on a downlink control channel (such as a PDCCH-Physical Downlink Control Channel), comprising downlink control information (DCI) which indicates (grants) downlink resources that are to be used to transmit the data, e.g. on a downlink shared channel (such as a PDSCH).

From this DCI, the communications device can determine uplink resources to use to send uplink control information (UCI) comprising an ACK or NACK in respect of the data, e.g. on an uplink control channel (such as a PUCCH), although it may also be on an uplink shared channel (such as a PUSCH). The communications device then seeks to receive the data on the indicated resources on the PDSCH. If the communications device successfully decodes the data, then the communications device transmits UCI on the determined uplink resources comprising an ACK. If the communications device does not successfully decode the data, the communications device transmits UCI on the determined uplink resources comprising a NACK. This allows the infrastructure equipment to determine if it should schedule a retransmission of the data.

So as to provide some particular examples, certain examples will be described herein in the context of HARQ-ACK transmissions in respect of downlink transmissions of data associated with XR applications, where URLLC functionality is relevant, and using terminology, for example in respect of channel names such as PUCCH and PDSCH and signalling names, such as DCI and UCI, which are typically used in connection with current 3GPP wireless communications networks. However, it will be appreciated this is only for convenience, and in general the approaches discussed herein are applicable for other service types and in wireless communications networks which use different terminology. Thus, references herein to PUCCH should, unless the context demands otherwise, be read as referring to a physical uplink control channel generally, and not specifically to a particular format of physical uplink control channel, and so on for other channels and terminology that may be referred to herein.

As will be appreciated, resources of a wireless access interface comprise a grid of communications resources (i.e. a radio frame structure) spanning frequency and time. The frequency dimension is divided into sub-carriers and the time dimension is divided into OFDM symbols that are grouped into slots and sub-slots.

### PDSCH HARQ-ACK Feedback

In a Dynamic Grant PDSCH (DG-PDSCH), the PDSCH resource is dynamically indicated by the gNB using a DL Grant carried by Downlink Control Information (DCI) in a Physical Downlink Control Channel (PDCCH).

A PDSCH is transmitted using HARQ transmission, where for a PDSCH ending in slot n, the corresponding Physical Uplink Control Channel (PUCCH) carrying the HARQ-ACK is transmitted in slot n+K₁. Here, in Dynamic Grant PDSCH, the value of K₁ is indicated in the field “PDSCH-to-HARQ_feedback timing indicator” of the DL Grant (carried by DCI Format 1_0, DCI Format 1_1 or DCI Format 1_2). Multiple (different) PDSCHs can point to the same slot for transmission of their respective HARQ-ACKs, and these HARQ-ACKs (in the same slot) are multiplexed into a single PUCCH. Hence, a PUCCH can contain multiple HARQ-ACKs for multiple PDSCHs.

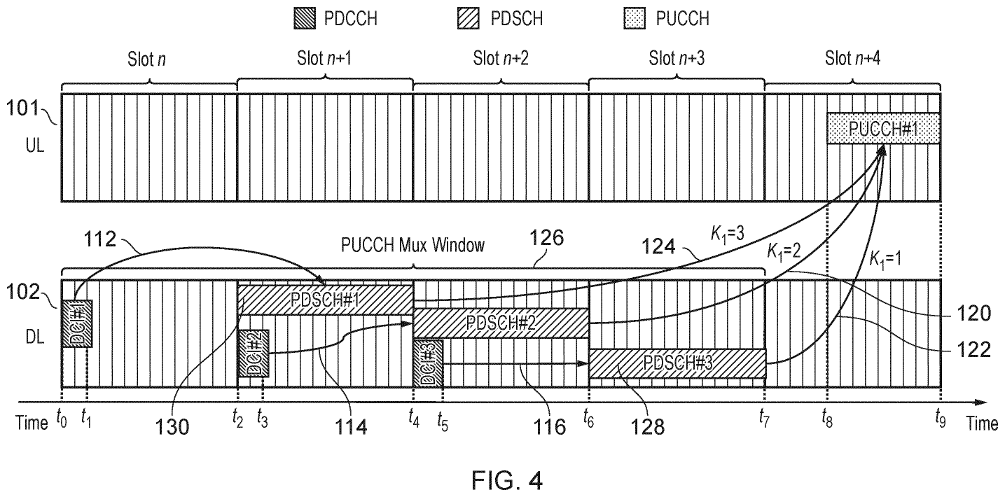

An example of this is shown in FIG. 4, where three DL Grants are transmitted to the UE via DCI #1, DCI #2 and DCI #3 in slot n, n+1 and n+2 respectively on a DL of a wireless access interface 102. DCI #1, DCI #2 and DCI #3 schedule PDSCH #1, PDSCH #2 and PDSCH #3 respectively as represented by arrow 112, 114, 116. DCI #1, DCI #2 and DCI #3 further indicate K₁=3, K₁=2 and K₁=1 respectively, which determine the uplink channel resource of the UL channel 101, as represented by arrows 120, 122, 124. Since the K₁ values indicate that the HARQ-ACK feedback for PDSCH #1, PDSCH #2 and PDSCH #3 are all to be transmitted in slot n+4, the UE multiplexes all of these HARQ-ACKs into a single PUCCH, i.e. PUCCH #1. The PUCCH Multiplexing Window is a time window where PDSCHs can be multiplexed into that single PUCCH, and the size of the PUCCH multiplexing window depends on the range of K₁ values. In the example in FIG. 4, the PUCCH Multiplexing Window is from Slot n to Slot n+3 (i.e. between time t₀ and time t₇), which means the max K₁ value is 4 slots.

In some examples, only one PUCCH per slot is allowed to carry HARQ-ACKs for the same UE, even if the different PUCCHs do not overlap in time they are considered to be in collision. The PUCCH resource is indicated in the “PUCCH Resource Indicator” (PRI) field in the DL Grant. Each DL Grant may indicate a different PUCCH resource, but the UE will follow the PRI indicated in the last PDSCH in the PUCCH Multiplexing Window since the UE only knows the total number of HARQ-ACK bits after the last PDSCH is received.

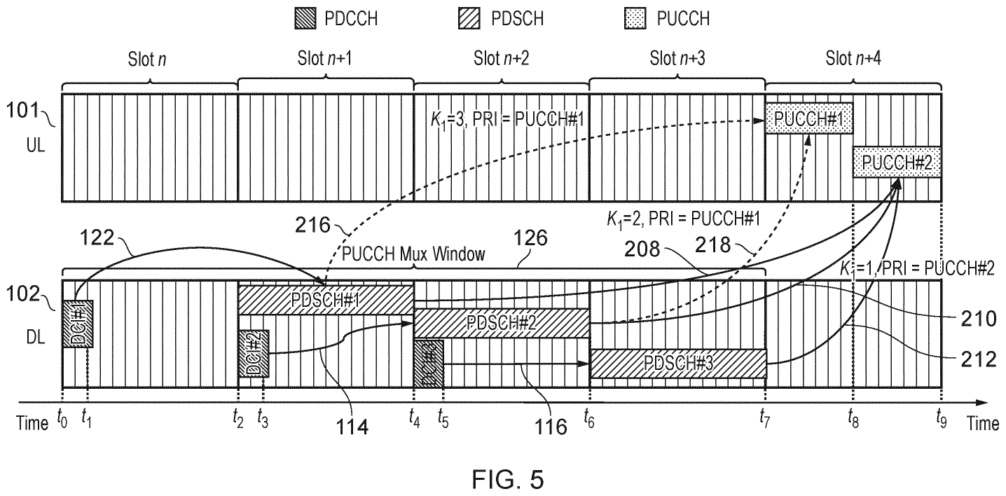

An example of this is shown in FIG. 5, which corresponds to the example of FIG. 4, where DCI #1 and DCI #2 indicate PUCCH #1 for the HARQ-ACKs corresponding to PDSCH #1 and PDSCH #2, but DCI #3 indicates PUCCH #2 for the HARQ-ACK corresponding to PDSCH #3, as represented by arrows 212, 216, 218. Here, PUCCH #1 and PUCCH #2 do not overlap in time. Since DCI #3 schedules the last PDSCH, i.e. PDSCH #3, in the Multiplexing Window, the UE will use PUCCH #2 to carry the HARQ-ACKs for PDSCH #1, PDSCH #2 and PDSCH #3 as represented by arrows 208, 210, 212. It should be noted here that a PUCCH carrying other UCI such as SR (Scheduling Request) can be transmitted separately to a PUCCH carrying HARQ-ACKs within the same slot if they do not overlap in time.

A sub-slot PUCCH has been introduced for eURLLC for carrying HARQ-ACKs for URLLC PDSCHs. Sub-slot based PUCCHs allow more than one PUCCH carrying HARQ-ACKs to be transmitted within a slot. This gives more opportunity for PUCCHs carrying HARQ-ACKs for PDSCHs to be transmitted within a slot, thereby reducing latency for HARQ-ACK feedback.

In a sub-slot based PUCCH, the granularity of the K₁ parameter (i.e. the time difference between the end of a PDSCH and the start of its corresponding PUCCH) is in units of sub-slots instead of units of slots, where the sub-slot size can be either two symbols or seven symbols.

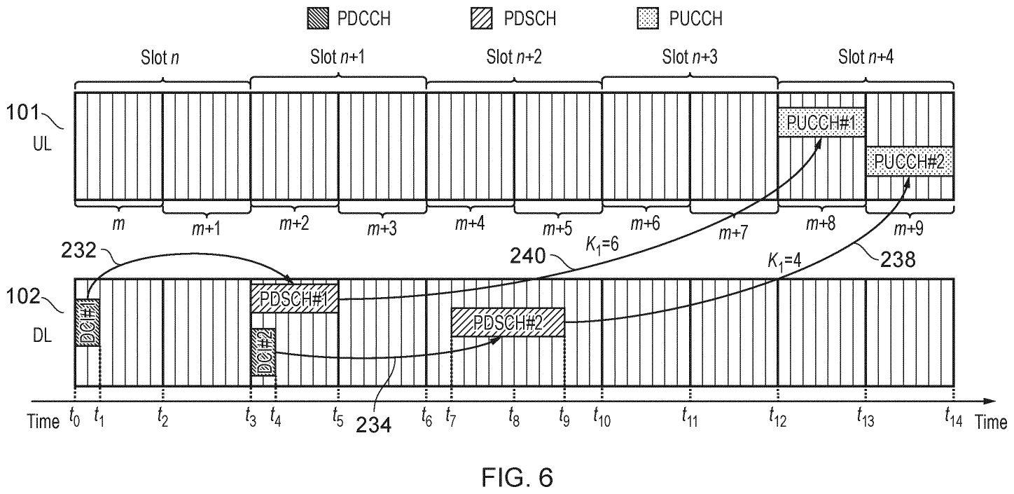

An example of this is shown in FIG. 6, which corresponds to FIGS. 4 and 5, where the sub-slot size equals seven symbols (i.e. half a slot) and the sub-slots are labelled as m, m+1, m+2, etc. PDSCH #1 is transmitted in slot n+1 but for sub-slot based HARQ-ACK PUCCH, it is considered to be transmitted in sub-slot m+2 and here K₁=6 which means that the corresponding HARQ-ACK is in sub-slot m+2+K₁=m+8. PDSCH #2 is transmitted in slot n+2 but occupies sub-slots m+4 and m+5. The reference for K₁ is relative to the sub-slot where the PDSCH ends, and in this case PDSCH #2 ends in sub-slot m+5. The DL Grant in DCI #2 that schedules PDSCH #2 indicates K₁=4, which schedules a PUCCH for its HARQ-ACK at sub-slot m+5+K₁=sub-slot m+9.

### Semi-Persistent Scheduling (SPS)

As is well understood by those skilled in the art, a gNB uses a PDSCH for downlink data transmission to a UE. The PDSCH resources used for the transmission of the PDSCH can be scheduled by a gNB either dynamically, or through the allocation of Semi-Persistent Scheduling (SPS) resources.

Similarly, to the use of Configured Grants (CGs) in the uplink, the use of SPS in the downlink reduces latency, particularly for regular and periodic traffic. The gNB is required to explicitly activate and deactivate SPS resources when it determines they may be required. These SPS resources are typically configured via Radio Resource Control (RRC) signalling, and occur periodically where each SPS PDSCH occasion has a pre-configured and fixed duration. This allows the gNB to schedule traffic that has a known periodicity and packet size. The gNB may or may not transmit any PDSCH in any given SPS PDSCH occasion, and so the UE is required to monitor each SPS PDSCH occasion for a potential PDSCH transmission.

In some implementations, the UE can only be configured with one SPS PDSCH and this SPS PDSCH is activated using an activation DCI (Format 1_0 or 1_1) with the Cyclic Redundancy Code (CRC) scrambled with a Configured Scheduling Radio Network Temporary Identifier (CS-RNTI). Once an SPS PDSCH is activated, the UE will monitor for a potential PDSCH in each SPS PDSCH occasion of the SPS PDSCH configuration without the need for any DL Grant until the SPS PDSCH is deactivated. Deactivation of the SPS PDSCH is indicated via a deactivation DCI scrambled with CS-RNTI. The UE provides a HARQ-ACK feedback for the deactivation DCI, but no HARQ-ACK feedback is provided for an activation DCI.

Similar to DG-PDSCH, the slot containing the PUCCH resource for HARQ-ACK corresponding to SPS PDSCH is indicated using the K₁ value in the field “PDSCH-to-HARQ_feedback timing indicator” of the activation DCI. Since a dynamic grant is not used for SPS PDSCH, this K₁ value is applied for every SPS PDSCH occasion, and can only be updated after it has been deactivated and re-activated using another activation DCI with a different K₁ value.

Since there is only one SPS PDSCH, PUCCH Format 0 or 1 is used to carry the HARQ-ACK feedback. If the PUCCH collides with a PUCCH carrying HARQ-ACK feedback for a DG-PDSCH, the HARQ-ACK for SPS PDSCH is multiplexed into the PUCCH corresponding to the DG-PDSCH.

In more recent implementations, the UE can be configured with up to eight SPS PDSCHs, where each SPS PDSCH has an SPS Configuration Index that is RRC configured. Each SPS PDSCH is individually activated using a DCI (Format 1_0, 1_1, and 1_2) with the CRC scrambled with CS-RNTI, where the DCI indicates the SPS Configuration Index of the SPS PDSCH to be activated. However, multiple SPS PDSCHs can be deactivated using a single deactivation DCI. Similar to older implementations, the UE provides a HARQ-ACK feedback for the deactivation DCI, but does not provide one for the activation DCI.

The slot or sub-slot containing the PUCCH resource for HARQ-ACK feedback corresponding to an SPS PDSCH occasion is determined using the K₁ value indicated in the activation DCI. Since each SPS PDSCH configuration is individually activated, different SPS PDSCH can be indicated with different K₁ values.

Since different K₁ values can be used for different SPS PDSCH configurations, it is possible that the HARQ-ACK for multiple SPS PDSCHs point to the same slot or sub-slot, and in such a scenario, these HARQ-ACKs are multiplexed into a single PUCCH. For multiple SPS

PDSCH configurations, PUCCH Format 2, 3, and 4 (in addition to PUCCH Format 0 and 1) can be used to carry multiple HARQ-ACKs for SPS PDSCH. Here, the HARQ-ACKs in the PUCCH are sorted in ascending order according to the DL slot for each of the SPS PDSCH Configuration Indices, and then sorted in ascending order of SPS PDSCH Configuration Index. It should be noted here that since typically the K₁ value is fixed per SPS PDSCH then it is unlikely to have two or more SPS PDSCH with the same index being multiplexed into a PUCCH.

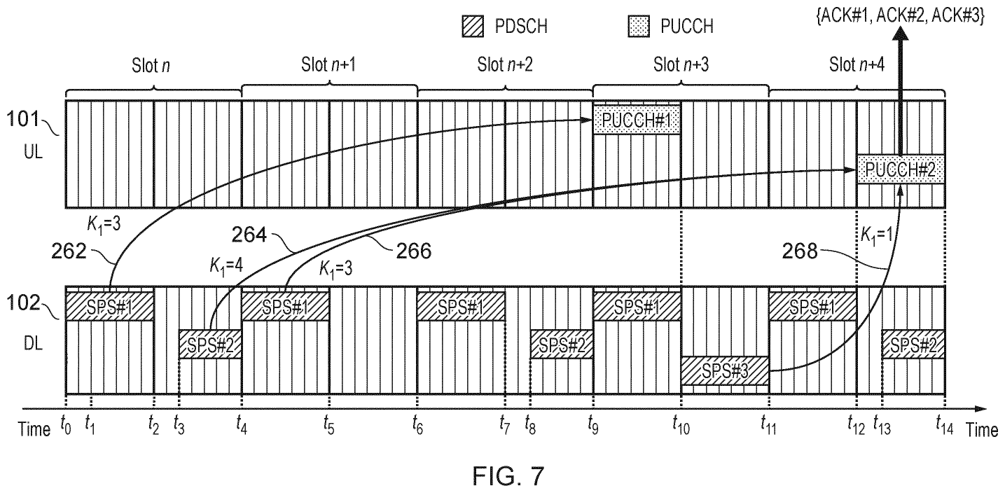

An example of this is shown in FIG. 7, where a UE is configured with three SPS PDSCHs labelled as SPS #1, SPS #2 and SPS #3 with different periodicities that are RRC configured with SPS Configuration Index 1, 2 and 3 respectively. SPS #1, SPS #2 and SPS #3 are activated with K₁=3, K₁=4 and K₁=1 respectively. These K₁ values result in the PUCCH for HARQ-ACK feedback corresponding to SPS #2 in Slot n, SPS #1 in Slot n+1 and SPS #3 in Slot n+3 being in the same slot, i.e. carried by PUCCH #2 in Slot n+4, as represented by arrows 262, 264, 266, 268. PUCCH #2 therefore provides 3 HARQ-ACKs labelled as {ACK #1, ACK #2, ACK #3} for SPS #1, SPS #2 and SPS #3 respectively according to their SPS PDSCH Configuration Indices (it can be seen that, in this example, there is only one unique SPS PDSCH per DL slot that has HARQ-ACK multiplexed into PUCCH #2).

In some implementations, when the PUCCH for an SPS PDSCH collides with the PUCCH for a DG-PDSCH, their HARQ-ACKs are multiplexed, where the SPS PDSCH HARQ-ACKs are appended after those for DG-PDSCH, if they have the same priority. Otherwise, one of the PUCCHs is prioritised.

### Extended Reality (XR) and Cloud Gaming

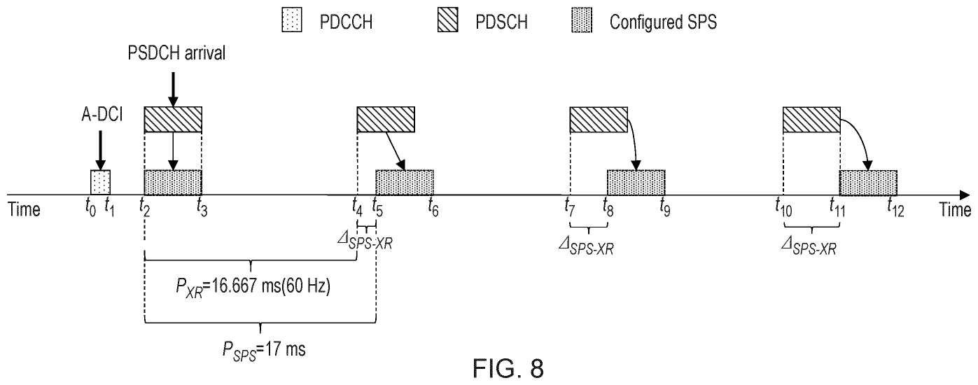

extended Reality (XR) and refer to various types of augmented, virtual, and mixed environments, use case, where human-to-machine and human-to-human communications are performed with the assistance of handheld and wearable end user devices (UEs). Cloud gaming is another feature, where gaming support is distributed ion the network. XR and Cloud Gaming are considered important for NR Rel-18 and beyond (also known as 5G Advanced). Hence, a Rel-18 Study Item on XR has been approved in 3GPP [5] to study potential enhancements to the legacy 5G system for support of XR traffic. XR traffic is rich in video, especially in the downlink, with a typical frame rate of 60 Hz [2], which leads to a data transmission with non-integer periodicity in NR, i.e. a periodicity of data transmission frames is not an integer number of subframes and, in this example, the periodicity is 16.67 ms. However, SPS uses integer periodicity (e.g. in 1 ms increments), and as such there will be a difference between a PDSCH arrival time and the start of the nearest SPS. This difference (or delay) is labelled Δ_{SPS-XR} and will increase with each SPS occurrence, as shown in FIG. 8. In particular, as the periodicity of the XR packet arrival is P_{XR}=16.667 ms, and because SPS uses integer periodicity, an SPS periodicity of P_{SPS}=17 ms is configured. At time t₀, an Activation DCI (A-DCI) is transmitted to the UE to activate the SPS and, for the first SPS occasion, the PDSCH packet arrival matches (i.e. is the same as) the start of the SPS PDSCH, i.e. Δ_{SPS-XR}=0. In the second SPS occasion, the PDSCH packet arrives at time t₄, whilst the SPS PDSCH starts at time t₅, and as such there is a delay of Δ_{SPS-XR}=17 ms−16.667 ms=0.333 ms. The delay Δ_{SPS-XR} increases to 0.6667 ms in the third SPS occasion at time t₈ and in the fourth SPS occasion at time t₁₁, the delay Δ_{SPS-XR}=1 ms. In other words, the timing of the PDSCH and the SPS occasion is off by an entire slot.

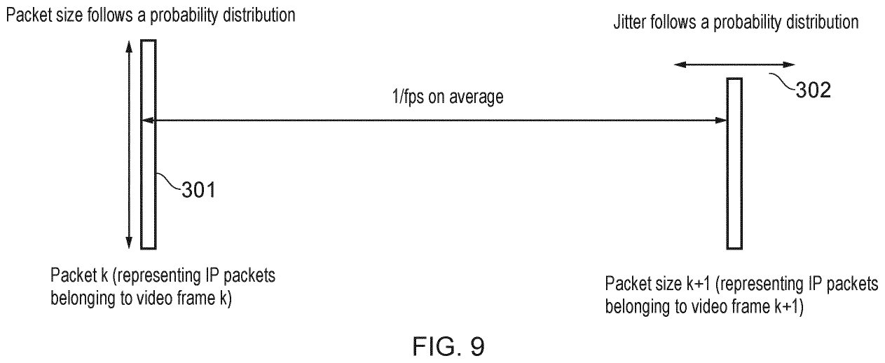

Furthermore, due to varying frame encoding delay and network transfer time, arrival of a packet to be transmitted to the UE at the gNB may experience random jitter. Frame rate and jitter of DL traffic is illustrated in FIG. 9. Packet arrival time 302 may experience jitter, whereby, as an example, the probability distribution is a normal or Gaussian distribution, a Poisson distribution or another such suitable distribution. The non-integer and jitter characteristics of XR traffic is known as quasi-periodic traffic. In the legacy 5G system, traffic with known periodicity and packet size, e.g. voice, is typically supported using Semi-Persistent Scheduling (SPS) PDSCH and Configured Grant PUSCH (CG-PUSCH). Packet size 301 of XR traffic may also not be constant and may similarly follow a probability distribution, as shown in FIG. 9. This is discussed later in more detail.

Although a packet arrival of packets for some services, for example XR services, may be periodic, the actual arrival time of the packet may experience jitter causing it to arrive randomly within a jitter time window, T_{Jitter}. An example is shown in FIG. 10, where an XR application communicates data over a certain bandwidth generating data packets as periodic traffic with a periodicity of P_{App}. FIG. 9 provides a representation of a transmission of data on PDSCH resources scheduled as a SPS resource, in which each of four boxes 262 within two example jitter time windows T_{Jitter} 128 are shown in a simplified form with respect to that of FIGS. 4 to 7 with respect to time 401. However, this traffic experiences jitter and so the actual packet arrival falls within a time window T_{Jitter}. In this example, the first jitter time window starts at time t₀ where the packet can arrive within this time window between t₀ to t₄ and here the packet arrives at time t₁. The next packet arrives after a time P_{App} later, starting at time t₅, and here once again the packet can arrive at any time within the jitter time window between t₅ to t₉. In the second instance, the packet arrives at time t₈, which is towards the end of the jitter time window T_{Jitter} as shown in a shaded box 402.

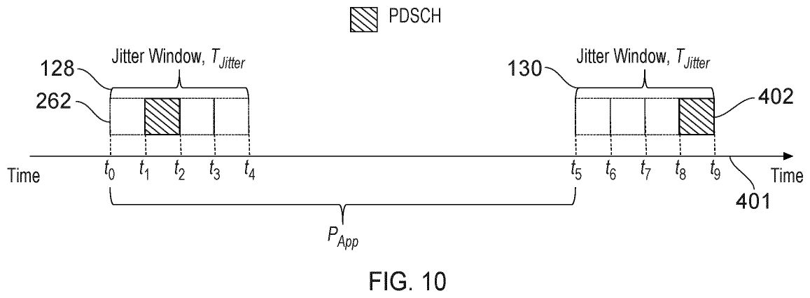

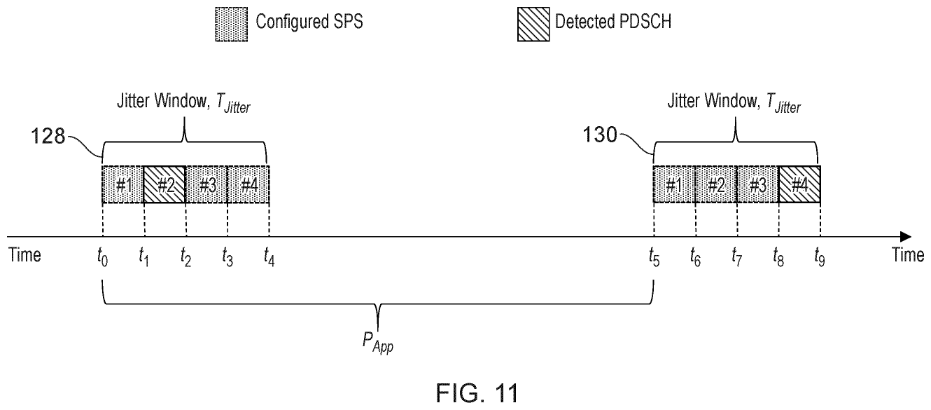

SPS configuration provides PDSCH resources to the UE with a deterministic periodicity, which can be from 1 to 640 slots. It may be recognised that such deterministic periodicity configuration is not suitable for traffic experiencing jitter. In one example, in order to account for jitter, and to have the data reliably received by the UE, multiple SPS configurations are used, where each SPS configuration may be activated with a different starting offset, i.e. different K₀, as indicated in a DCI field “Time Domain Resource Assignment” (TDRA). That is, SPS resources can be over-configured to support jittering. In the example in FIG. 9, the UE can be configured with 4 SPS PDSCH configurations, such that these 4 SPS fall within the jitter time window and each has a periodicity of P_{APP}. A further example is shown in FIG. 11, and for the sake of conciseness, only differences between FIGS. 10 and 11 will be described. In this Figure, 4 SPS configurations labelled as #1, #2, #3 and #4 with periodicity P_{App}, but different offsets, are configured for a UE. Hence, by configuring multiple SPS resources, the UE may therefore be provided with PDSCH resource whenever the packet data arrives within the jitter time window. As will be appreciated from a consideration of the two Figures, the transmission of the data in each occurs in SPS #2 in the first Jitter window 128, and in the SPS #4 in the second jitter window 130. However, this is not a limitation of the SPS resource in which the PDSCH may be transmitted, and the data may be transmitted in any of the resources, as governed by the probability distribution.

### Transport Block Size

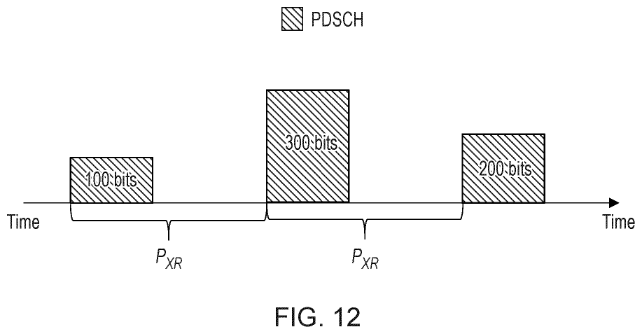

One further characteristic of XR traffic is that the quantity of application data arriving at a UE within a given time period is not constant. Instead, the amount of application data included within PDSCH transmissions may vary, for example within a given range. As such, PDSCH transmissions for XR traffic may have a non-fixed Transport Block Size (TBS). An example is shown in FIG. 12, where the XR traffic has a periodicity of P_{XR}. In the first SPS occasion, the application data uses a PDSCH with TBS=100 bits, in the second SPS occasion, the application data uses a PDSCH with TBS=300 bits and in the third SPS occasion, the application data uses a PDSCH with TBS=200 bits. However, in general for a given SPS configuration, the TBS for a PDSCH is fixed.

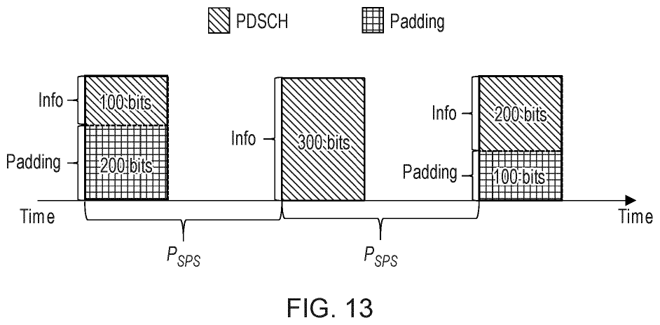

FIG. 13 shows a legacy approach for managing variable application data amounts, where SPS resources are over-configured. For example, to support the non-fixed application data size for the PDSCH, the SPS instance may be activated with a large TBS for the PDSCH to ensure the largest packet size can be carried. For smaller packet sizes, the PDSCH is padded (e.g. with zeros) to ensure the total TBS for each PDSCH is the same. For example, if the maximum TBS is 300 bits, then the gNB can activate a configured SPS with TBS=300 bits for the PDSCH, as shown in FIG. 13. In the first SPS occasion, the application data requires a TBS=100 bits, but since the SPS is activated with a PDSCH TBS=300 bits, 200 bits of padding are added to the PDSCH. In the second SPS occasion, the application data requires TBS=300 bits and here no padding bits are required. In the third SPS occasion, the application data requires TBS=200 bits and so 100 bits of padding is required. While this allows variable packet size across SPS occasions, this approach involves the over-configuration of SPS resources, and is therefore inefficient.

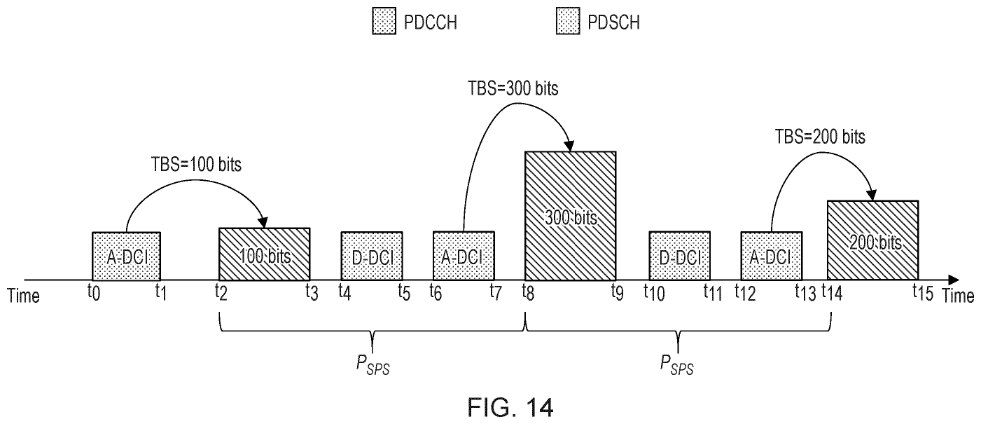

Another approach to support XR traffic with changing application data size is to deactivate an SPS instance and re-activate it with different parameters (e.g. MCS (Modulation & Coding Scheme), FDRA (frequency resources) and TDRA (time resources)) so that it provides the required TBS to carry the application data. This is shown in Figure 14Error! Reference source not found., where at time t₀, an Activation DCI (A-DCI) is transmitted to the UE, which activates an SPS with PDSCH TBS=100 bits. After transmitting the PDSCH in the first SPS occasion, the gNB transmits a Deactivation DCI (D-DCI) to deactivate the SPS followed by an Activation DCI to re-activate the SPS with a PDSCH TBS=300 bits so that in the second SPS occasion to carry the increased application data. At time t₁₀, another Deactivation DCI is transmitted to deactivate the SPS again followed by an Activation DCI at time t₁₂ to change the PDSCH TBS of the third SPS occasion to a TBS=200 bits. This implementation consumes high DCI overheads as each change required a Deactivation DCI and an Activation DCI. If the PDSCH TBS requires very frequent changes, then the DCI overhead may be higher than using Dynamic Grant PDSCH (i.e. where each PDSCH is individually and dynamically scheduled).

Recognising these limitations in legacy SPS implementations, the present inventors have identified improved embodiments for SPS PDSCH transmissions (for example for XR traffic), which address at least some of these shortcomings.

### Update DCI

Embodiments of this disclosure relate introduce an Update-DCI (U-DCI) to update one or more parameters for one or more SPS instances. That is, a U-DCI may be transmitted by the gNB to the UE to update the configuration of an SPS instance for one or more occasions of the SPS instance. This is achieved without sending a D-DCI to the UE. This is in contrast to legacy SPS implementations where, in order to change an SPS parameters (e.g. MCS or TBS), the gNB needs to deactivate the SPS (with a D-DCI) and then reactivate it again using a different parameters in the A-DCI (see e.g. FIG. 14). The following embodiments describe the transmission of an Update DCI.

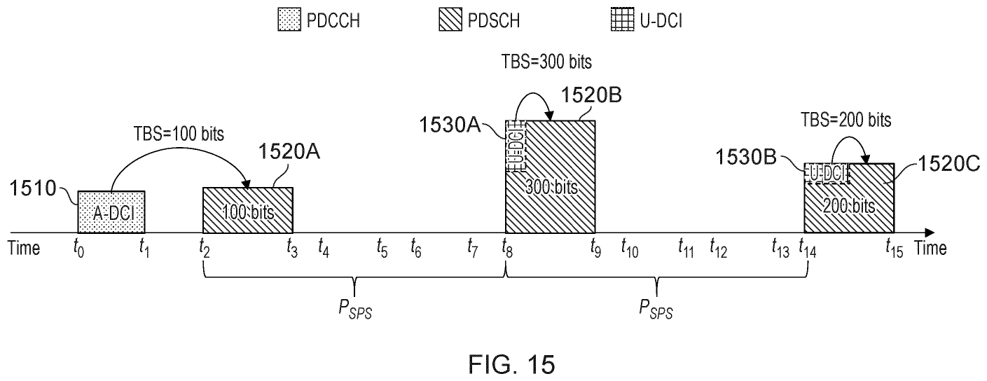

In one example, the U-DCI is embedded within the PDSCH of SPS. That is, the DCI bits are transmitted with the PDSCH during an SPS occasion. An example is shown in FIG. 15, where at time t₀, an A-DCI 1510 activates an SPS with PDSCH TBS=100 bits. At time t₂, in the first SPS occasion, a PDSCH 1520A is transmitted with TBS=100 bits. At time t₈, in the second SPS occasion the application data requires TBS=300 bits and as per this example, an embedded U-DCI 1530A is transmitted together with the PDSCH 1520B in the second SPS occasion, indicating that the PDSCH's TBS has changed to 300 bits. In the third SPS occasion, the PDSCH 1520C is transmitted with an embedded U-DCI 1530B indicating the PDSCH TBS has changed to 200 bits.

Compared to the legacy approach of FIG. 13, this embodiment does not require over configuration of the PDSCH TBS and the use padding bits, thereby conserving resources. The present example also has significantly less PDCCH overhead compared to the legacy method in Figure 14.Error! Reference source not found.

There are a number of ways in which the U-DCI may be included within a PDSCH. For example, the U-DCI and the application data within the PDCSH may be encoded differently. For example, the control information in the U-DCI can be encoded using Polar coding or Reed-Muller coding, whilst the application data for the PDSCH may be encoded using low-density parity-check (LDPC). In another example, both the U-DCI and the application data within the PDCSH can be encoded with different coding rates. In another example, the U-DCI and application data within the PDSCH are separately modulated. For instance, the U-DCI can be modulated with BPSK or QPSK, whilst the application data for the PDSCH may be modulated with a higher modulation scheme (e.g. 16, 64, or 256 QAM). In other words, a U-DCI may be modulated with a lower order modulation scheme and the application data for the PDSCH may be modulated with a higher order modulation scheme. A lower order modulation scheme is more robust than a higher order modulation scheme, and a high degree of is required for a U-DCI in order to ensure that the subsequent downlink transmission can be decoded correctly.

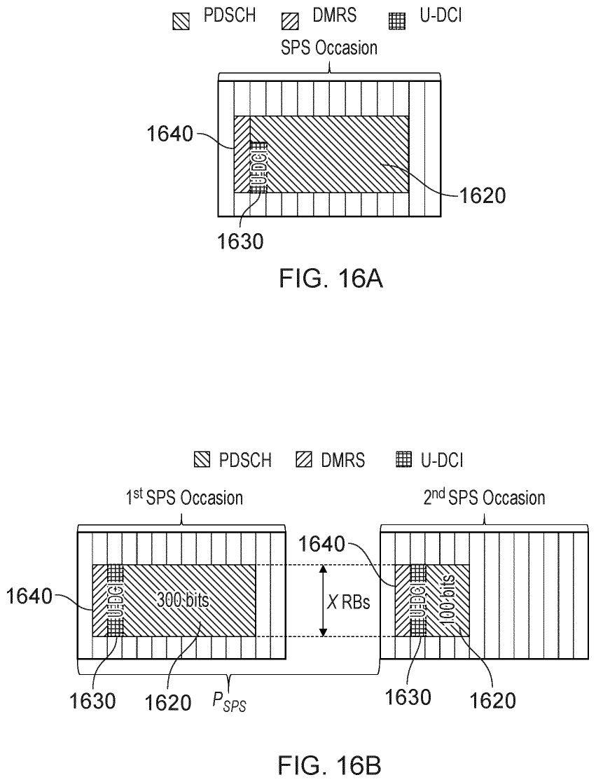

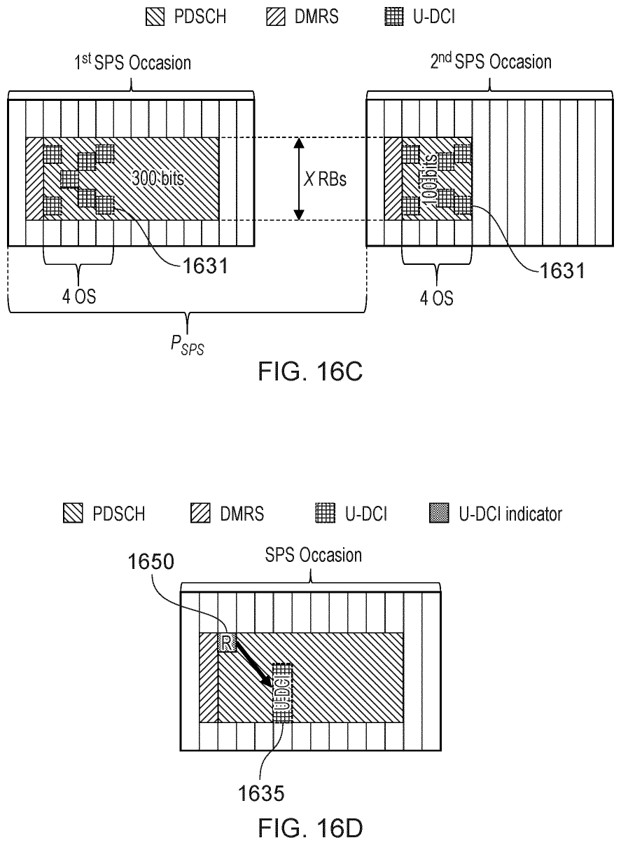

In some examples, the U-DCI may be mapped to particular locations within the PDSCH. For example, the U-DCI may be mapped to a particular orthogonal frequency division multiplexing (OFDM) symbol of the PDSCH. FIG. 16A shows an example of such an arrangement. In FIG. 16A, OFDM symbols including the U-DCI 1630 (e.g. the U-DCI modulated symbols) are mapped to earlier OFDM symbols than the symbols for the application data 1620 of the PDSCH. The PDSCH starts from the second OFDM symbol and has a duration of 11 OFDM symbols, where the first OFDM symbol of the PDSCH (i.e. the second OFDM symbol of the slot) contains the demodulation reference signal (DMRS) 1640. The second OFDM symbol of the PDSCH (i.e. the third OFDM symbol of the slot) contains the U-DCI 1630, which is mapped first, as per this example. It should be appreciated that the U-DCI 1630 does not need to occupy the entire OFDM symbol, i.e. it does not need to occupy all the physical resource blocks (PRBs) allocated to the PDSCH on that OFDM symbol, and may instead occupy a predetermined set of PRBs.

A benefit of this example is that the UE can decode the U-DCI 1630 first to determine the PDSCH parameters, such as the TBS, i.e. the MCS, frequency & time resources for the PDSCH. That is, once the U-DCI 1630 is decoded, the UE can start decoding the rest of the PDSCH. When decoding the PDSCH, the UE may in some examples avoid the U-DCI 1630 resource elements (REs), i.e. the REs containing the U-DCI 1630 are not part of the application data 1620 in the rest of the PDSCH. In addition, the UE may use the U-DCI 1630 as an additional reference signal to improve its channel estimation.

In another example, the U-DCI 1630 may be mapped to a known (i.e., preconfigured) frequency and time resource (i.e. OFDM symbols and RBs) in an SPS occasion, as shown in FIG. 16B. This recognizes that the UE may not know the frequency and time resource of the PDSCH without reading the U-DCI 1630 and so by fixing the U-DCI 1630 location in every SPS occasion the UE knows where to decode the U-DCI 1630. For example, in FIG. 16B, the frequency resources are fixed to X RBs in every SPS occasion after the SPS is activated, and always starts at the second OFDM symbol. The first OFDM symbol of the PDSCH contains the DMRS and as per this example, the second OFDM symbol of the PDSCH always contains the U-DCI 1630, thereby fixing the frequency & time resource of the U-DCI 1630. It should be appreciated, however, that the U-DCI 1630 does not necessarily need to be located in the second OFDM symbol, but may instead be configured to always be located in substantially any OFDM symbol. For example, if the PDSCH has a minimum duration of 5 OFDM symbols, the U-DCI 1630 may always be mapped to any of OFDM symbols 2-5. Furthermore, the total number of OFDM symbols of the PDSCH can be changed to fit the required TBS. For example in FIG. 16B, in the first SPS occasion, the PDSCH occupies 11 OFDM symbols in which the last 9 OFDM symbols carry 300 information bits whilst in the second SPS occasion, the PDSCH contains 5 OFDM symbols in which the last 3 OFDM symbols carry 100 information bits. The U-DCI 1630 in this example indicates the changes to the number of OFDM symbols (i.e. size) of the PDSCH.

In another example, the U-DCI is distributed across known frequency & time resources, i.e. resource elements (REs), in an SPS occasion. Distributing the U-DCI provides some diversity gain for the U-DCI data. An example is shown in Figure 16CError! Reference source not found., where the U-DCI 1631 is distributed across X RBs and 4 OFDM symbols of the PDSCH. In the first SPS occasion, the UE would extract the distributed U-DCI 1631 and, after decoding it, the UE knows that the PDSCH has a TBS=300 bits and occupies 11 OFDM symbols. In the second SPS occasion, the UE extracts the U-DCI 1631 from the same frequency & time locations in the slot and after decoding the U-DCI 1631 the UE determines that the PDSCH is 5 OFDM symbols long. In this example, the minimum duration of the PDSCH is 5 OFDM symbols, and as such the U-DCI 1631 is distributed across only the minimum number of OFDM symbols (i.e. OFDM symbols 2-5), regardless of the size of the PDSCH. Furthermore, the U-DCI 1631 may have a fixed number, X, of RBs to ensure the REs within these resources are mapped to the U-DCI 1631. The distribution of the U-DCI 1631 may be known in advance and provided to the UE (for example via RRC signaling, or may be provided in the Activation DCI, or defined in the specifications).

In another example, the PDSCH may include an indicator 1650 which indicates whether there is U-DCI 1635 or not. The indicator 1650 may be a reserved allocation of the PDSCH with a resource size that is typically much smaller than the U-DCI 1635, and can be part of the U-DCI or a separate resource, as shown in FIG. 16D. For example, the indicator 1650 can be an RE within the U-DCI 1635 or generally within the entire PDSCH slot. In some examples, the indicator 1650 can be represented as one bit. In such an example, if the bit has a value of 1 this may indicate that there are some resources allocated for a U-DCI 1635. If the bit has a value of 0, this may indicate there is no U-DCI 1635 in that particular SPS occasion and the U-DCI 1635 resource can, in some cases, be allocated for application data within the PDSCH.

The configuration information for the U-DCI (e.g. the location, format, encoding, modulation) may be configured (i.e. provided to the UE) via RRC signaling, or may be included within the Activation DCI for the SPS instance.

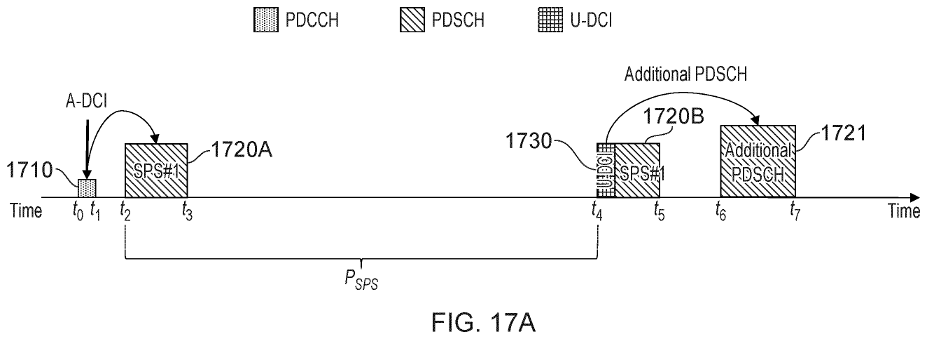

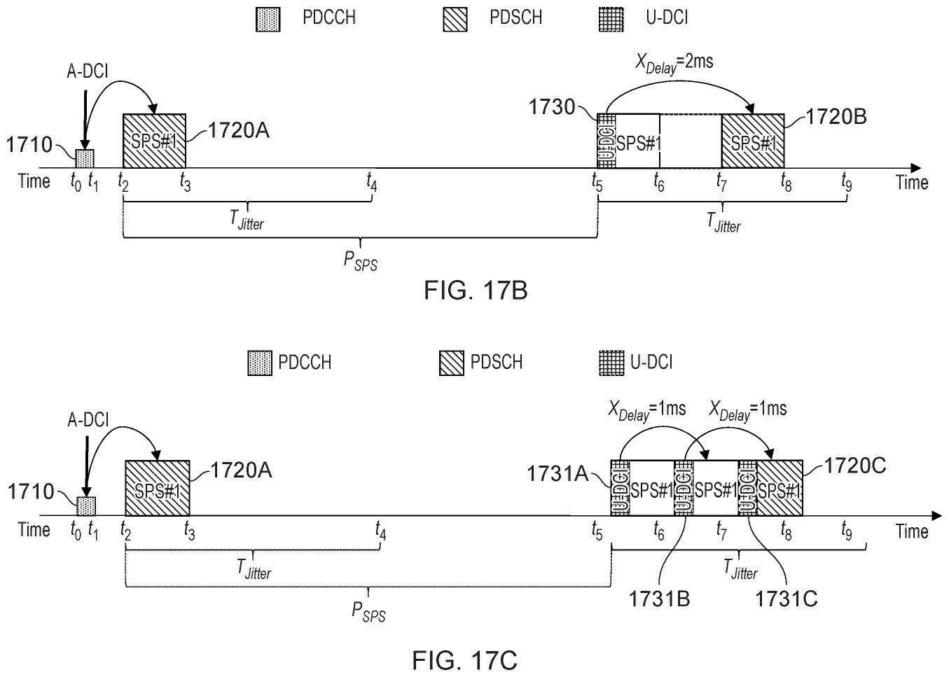

In some examples, the U-DCI may indicate that an additional PDSCH transmission is expected at a particular time after the SPS occasion. Accordingly, the UE may monitor for this additional PDSCH transmission, which may fall outside an SPS occasion. In such an example, the PDSCH within the SPS occasion may follow the parameters set out in the U-DCI. The parameters of the additional PDSCH indicated by the U-DCI, e.g. the time, frequency and TBS of the PDSCH, may be predetermined, i.e. the additional PDSCH may have a different TBS to the PDSCH in the SPS occasion. For example, the PDSCH parameters of the additional PDSCH may be configured by RRC signaling, or the PDSCH parameters of the additional PDSCH may be the same as the current SPS occasion. In other words, the TBS may be the same as the current SPS occasion, but the starting time of the additional PDSCH may be at a known offset from the SPS occasion. Alternatively, the starting time of the additional PDSCH may be indicated by the U-DCI. An example of this example is shown in FIG. 17A, where at time t₀, an A-DCI 1710 is transmitted to the UE to activate SPS #1 and the first SPS occasion of SPS #1 starts at time t₂, where a first PDSCH 1720A is transmitted. In the second occasion of SPS #1 at time t₄, a second PDSCH 1720B is transmitted which includes a U-DCI 1730 that indicates the parameters for SPS #1 and, as per this example, it also indicates an additional PDSCH 1721 to start at time t₀.

In another example, the U-DCI may indicate that the PDSCH application data in the current SPS occasion is delayed, for example by X_{Delay} number of slots. X_{Delay} can be configured by RRC signaling, indicated in the activation DCI, indicated in the U-DCI or may be predetermined (i.e. fixed in the specifications). This example is beneficial to mitigate the jittering (discussed above) and non-integer periodicity associated with XR traffic. An example of this arrangement is shown in FIG. 17B, where XR traffic suffers from jittering with a jitter window T_{Jitter}=4 ms. At time t₀, an A-DCI 1710 is transmitted to the UE to activate SPS #1 which starts at time t₂. The first SPS occasion of SPS #1 at time t₂ contains a PDSCH 1720A and the UE decodes the PDSCH. In the second SPS occasion at time t₅, the PDSCH arrives 2 ms later due to jittering. As per this example, the U-DCI 1730 is transmitted at time t₅ and may indicate a value of X_{Delay}=2 ms, indicating that the current SPS #1 occasion does not contain application data (i.e. a payload of the PDSCH at t₅ includes only the U-DCI) and that the PDSCH 1720B containing the application data is delayed by 2 ms to time t₇. The UE is also aware that it has not received the application data, but that this is expected at a later time, and as such the UE refrains from transmitting a NACK. The gNB can allocate the unused PDSCH allocation in the SPS #1 occasion for other purposes/other UEs. Hence, resource utilization can be kept high.

In a similar example, the delayed SPS occasion can be further delayed by a subsequent U-DCI. An example is shown in FIG. 17C, where X_{Delay}=1 slot (or 1 ms) and the XR traffic suffers from jittering with T_{Jitter}=4 ms. At time t₀, an A-DCI 1710 is sent to the UE to activate SPS #1 where the first SPS occasion of SPS #1 starts at time t₂ and may include a PDSCH 1720A. In the second SPS occasion at time t₅, the application data of the PDSCH is delayed due to jittering, however a U-DCI 1731A is transmitted to the UE indicating that the application data of the PDSCH is delayed. When transmitting the U-DCI 1731A at t₅, the gNB may not know when the application data is going to be transmitted at that time and as such may delay the second SPS occasion by only a single slot to start at time t₀. At time t₀, the application data may still not have been transmitted and as such, a further U-DCI 1731B may be transmitted by the gNB which delays the second SPS occasion by a further slot to t₇. At time t₇, the PDSCH 1720C including the application data arrives and is transmitted in the delayed SPS occasion for SPS #1, where the delayed PDSCH 1720C may optionally include a U-DCI 1731C. In other words, a U-DCI 1731A, 1731B is present in the originally scheduled SPS occasion (which does not include application data) and the delayed SPS occasion (including the application data). This is beneficial for cases where the actual arrival of the application data of the PDSCH 1720C is not known at the time of the SPS occasion.

While the above examples of a U-DCI indicating that a PDSCH is delayed or that an additional PDSCH is expected (e.g. FIGS. 17A, 17B, and 17C) are described in relation to a U-DCI embedded within a PDCSH, it is appreciated that these techniques are equally applicable to other U-DCI implementations, such as those described below.

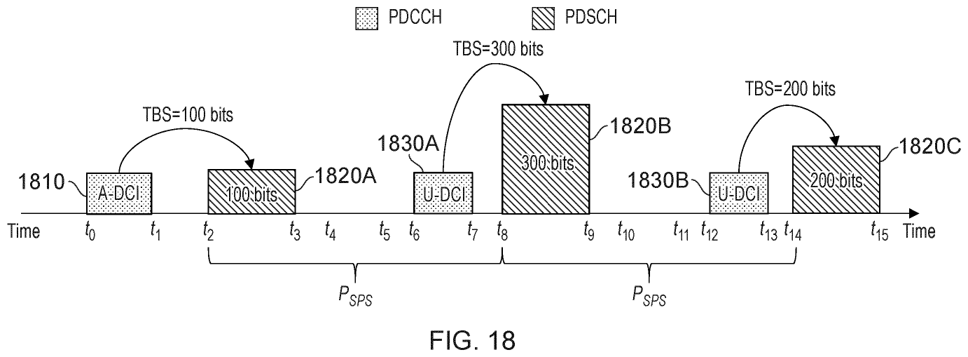

Instead of being embedded within a PDSCH, the U-DCI may instead be carried by a PDCCH transmitted before a PDSCH. An example is shown in FIG. 18, where an SPS is activated with an Activation DCI (A-DCI) 1810 at time t₀ with a PDSCH TBS=100 bits. A PDSCH 1820A with TBS=100 bits may then be transmitted at time t₂. At time t₀, a U-DCI 1830A is transmitted to the UE indicating that the SPS's PDSCH 1820B TBS is changed to 300 bits. Similarly, at time t₁₂, another U-DCI 1830B may be transmitted to indicate another change to the SPS's PDSCH 1820V TBS to 200 bits. This approach can also be applied to multiple UEs, where the U-DCI may be a Group Common DCI (GC-DCI) carried by a PDCCH, where the GC-DCI addresses multiple UEs in one DCI. The updates in the GC-DCI may then be applicable to the next SPS for each UE.

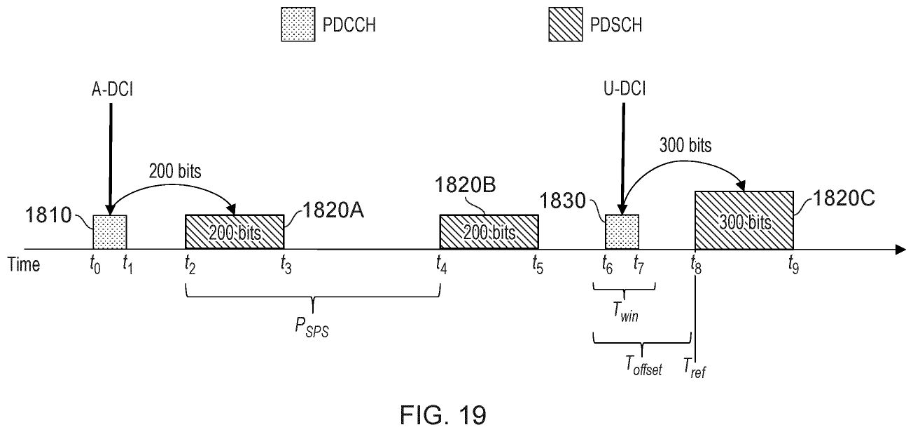

When a gNB is configured to transmit a U-DCI 1830 in a PDCCH, the gNB does not need to transmit a U-DCI 1830 prior to every SPS occasion if there are no changes to the PDSCH. However, the UE has to monitor every PDCCH search space where the U-DCI 1830 is configured. For example, the U-DCI 1830 may be transmitted in a predetermined location that is T_{offset} prior to the scheduled SPS occasion (or prior to a reference time, T_{ref}) and within T_{win} time window, as shown in FIG. 19. The UE may expect to receive the U-DCI 1830 in that given time window. If no U-DCI 1830 is received in the time window, the UE may determine that there is no update to the upcoming SPS occasion, and instead assumes a particular configuration (e.g. a previous configuration or a default configuration). In some examples, T_{offset} can be configured to be larger than an anticipated negative jitter in the arrival of the XR traffic.

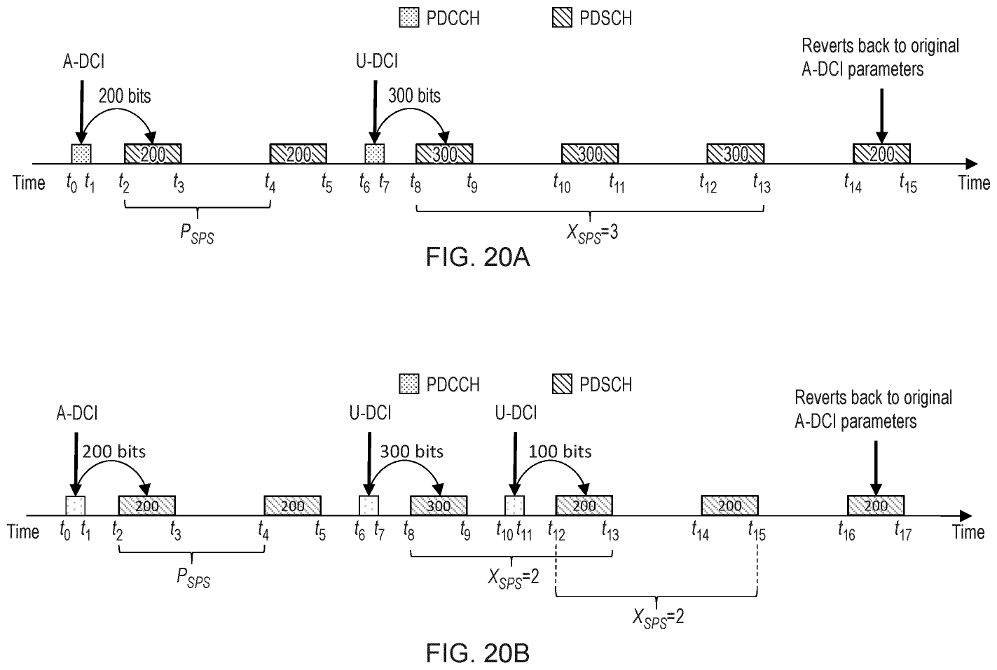

In some examples, the parameters in the U-DCI are used for a specific number of SPS occasions, e.g. the next X_{SPS} SPS occasion(s), or until another U-DCI is sent, whichever comes first. After X_{SPS} SPS occasions and if there are no further U-DCI transmissions, the SPS reverts back to the original parameters from the A-DCI. An example is shown in FIG. 20A, where an A-DCI at time t₀ activates an SPS with PDSCH TBS=200 bits. The first SPS occasion at time t₂ has a PDSCH TBS=200 bits following the A-DCI parameters. The second SPS occasion also follows the A-DCI parameters and has a PDSCH TBS=200 bits. At time t₆, a U-DCI updates the PDSCH TBS for the SPS to 300 bits and in this example X_{SPS}=3. As per this embodiment, the following 3 SPS occasions, i.e. the third, fourth and fifth SPS occasions at time t₀, t₁₀ and t₁₂ respectively have PDSCH TBS=300 bits. For the sixth SPS occasion at time t₁₄, the PDSCH TBS reverts back to 200 bits following the A-DCI parameters. This is particularly beneficial if a temporary spike in traffic is expected.

Another example is shown in FIG. 20B, where once again an A-DCI at time t₀ activates an SPS with PDSCH TBS=200 bits. At time t₀, a U-DCI updates the SPS PDSCH TBS to 300 bits and here X_{SPS}=2, i.e. the following two SPS occasions, i.e. the third and fourth SPS occasions at time t₈ and t₁₂ respectively would use PDSCH TBS=300 bits. However, prior to the start of the fourth SPS occasions, another U-DCI is transmitted to the UE at time t₁₀, which updates the SPS PDSCH TBS to 100 bits. The X_{SPS} counter is therefore reset and the fourth and fifth SPS occasions at time t₁₂ and t₁₄ respectively would use a PDSCH TBS=100 bits. As per the embodiment, after the X_{SPS} SPS occasions since the U-DCI update, at the sixth SPS occasion at time t₁₆, the SPS reverts back to the original A-DCI parameters, i.e. the PDSCH TBS reverts back to 200 bits.

In some implementations, X_{SPS} may be 1, such that the updated PDSCH parameters are applicable only for one SPS occasion. In other implementations, X_{SPS} may be infinite (e.g. indicated in the U-DCI by a value of 0), such that the updated PDSCH parameters are applicable until another U-DCI updates the parameters or the SPS is deactivated. The parameter X_{SPS} can be RRC configured for each SPS configuration or for several SPS configurations, indicated in the activation DCI, indicated in the U-DCI, or defined in the specifications. Furthermore, while the examples discussed in relation to FIGS. 20A and 20B above, namely the application of U-DCI to a set number of SPS occasions, are shown in the context of a U-DCI transmitted separately from a PDSCH (as a PDCCH), these examples are equally applicable to the other U-DCI implementations discussed above (e.g. embedded U-DCIs) and below.

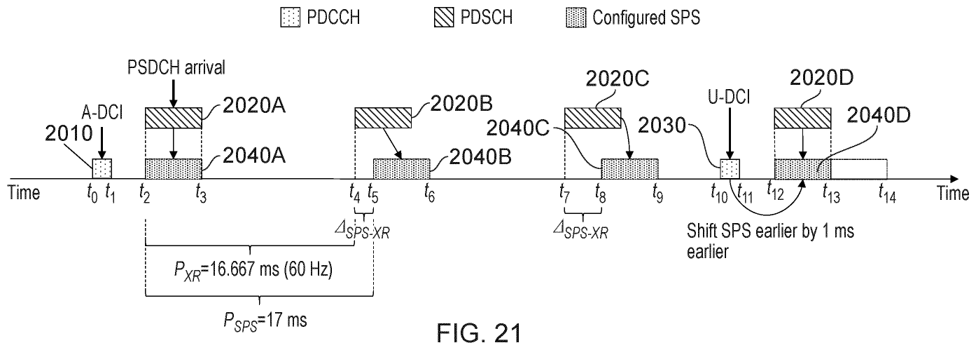

As the PDCCH-based U-DCI is transmitted prior to the start of the SPS PDSCH, it is possible to change the starting offset of an SPS instance, in addition to the TBS of the PDSCH. The U-DCI can indicate a different time domain resource allocation (TDRA) index with an earlier or later K₀ value, which is beneficial for XR traffic with non-integer periodicity. An example is shown in FIG. 21, where the XR periodicity is P_{XR}=16.667 ms (60 Hz). At time t₀, an SPS with a periodicity of P_{SPS}=17 ms is activated by an A-DCI 2010 and the first SPS occasion 2040A occurs at time t₂, which matches the arrival of the PDSCH 2020A carrying XR traffic.

In the second SPS occasion 2040B and third SPS occasion 2040C at times t₅ and t₈ respectively, the delay Δ_{SPS-XR}, in the arrival of PDSCHs 2020B, 2020C carrying XR traffic and the SPS that is used to transmit them increases, i.e. Δ_{SPS-XR}=0.333 ms and 0.667 ms in the second SPS occasion 2040B and the third SPS occasion 2040C respectively. Prior to the expected arrival of fourth PDSCH 2020D carrying XR traffic, a U-DCI 2030 is transmitted to the UE at time t₁₀ wherein the U-DCI 2030 indicates a new starting offset for the SPS, such that the upcoming SPS, i.e. the fourth SPS occasion 2040D is shifted earlier in time by 1 ms. The fourth SPS occasion 2040D thereby starts 1 ms earlier at time t₁₂, which matches the arrival of the PDSCH 2020D carrying XR traffic. If the U-DCI 2030 were not used, the fourth SPS occasion 2040D would instead have started at time t₁₃, which would lead to Δ_{SPS-XR}=1 ms.

In some examples, the UE feedbacks a HARQ-ACK when it successfully receives a U-DCI such that the gNB is aware that the UE has received the U-DCI. This ensures that the UE receives the updated parameters, since if the UE fails to receive the U-DCI, the UE may continuously fail to decode the PDSCH for X_{SPS} SPS occasions. The HARQ-ACK may, for example, be transmitted in a PUCCH.

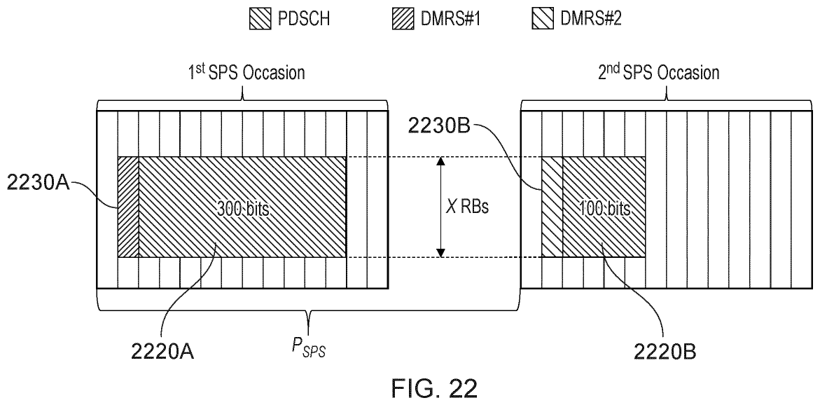

As an alternative to embedding a U-DCI within a PDSCH or transmitting the U-DCI as a PDCCH, the U-DCI may be transmitted via a demodulation reference signal (DMRS) for a PDSCH. In particular, each SPS instance can be configured with two or more DMRSs, where each DMRS indicates a set of parameters for PDSCH transmissions. An example is shown in FIG. 22, where an SPS instance is configured with two different DMRS 2230 at different SPS occasions, i.e. DMRS #1 2230A and DMRS #2 2230B. DMRS #1 2230A indicates a set of predefined parameters which give a PDSCH 2220A TBS=300 bits whilst DMRS #2 2230B indicates another set of parameters which give a PDSCH 2220B TBS=100 bits. In this example, the DMRS 2230 is transmitted in the first OFDM symbol of the PDSCH 2220 which allows the UE to determine the parameters to decode the PDSCH 2220. In the first SPS occasion, DMRS #1 2230A is used and so the corresponding PDSCH 2220A has TBS=300 bits, whilst in the second SPS occasion, DMRS #2 2230B is used which indicates a PDSCH 2220B TBS=100 bits. In other words, a UE may determine a particular set of parameters for the SPS based on a lookup according to the particular DMRS 2230 used.

It should be appreciated that although the example in FIG. 22 shows only two DMRSs, this example is not limited to 2 DMRSs and more than 2 DMRSs can be configured per SPS instance. Furthermore, a default DMRS may be defined for each SPS instance, such that the default DMRS may be used for at least for first SPS occasion after the SPS instance is activated with an Activation DCI. Furthermore, while particular examples are discussed in relation to a single U-DCI implementation (e.g. embedded within a PDSCH, transmitted via a PDCCH, or indicated by a DMRS), it should be appreciated that all examples discussed herein may be utilised regardless of the specific U-DCI implementation.

Furthermore, the precise format of the U-DCI may take a number of different forms. For example, the U-DCI may have the same format as an Activation DCI (A-DCI). In particular, the A-DCI format includes the parameters required to change an SPS instance's TBS (i.e. by changing the MCS, TDRA and FDRA) and the starting offset (i.e. by changing the TDRA), however the U-DCI is capable of changing these parameters for an existing SPS instance, without requiring deactivation of the SPS instance. In some examples, the U-DCI may use a particular RNTI to differentiate the U-DCI from a DL Grant (e.g. for a dynamic PDSCH). For example, the CRC of the U-DCI may be masked with a CS-RNTI. In certain examples the cyclic redundancy check (CRC) of the U-DCI may be scrambled with a dedicated radio network temporary identifier (RNTI). For example, an Update RNTI (U-RNTI) with a specific ID may be used specifically for U-DCI transmissions.

In current 3GPP specifications, an SPS index is indicated using a HARQ Process Number (HPN) field in the Activation and Deactivation DCI transmissions, combined with a New Data Indicator, NDI=0. That is, if a particular SPS instance with a particular SPS index has not been activated, an HPN pointing to that SPS index with NDI=0 indicates to the UE that it should activate that SPS instance with the particular SPS index. If a particular SPS instance with the particular SPS index has already been activated, an HPN pointing to that SPS index with NDI=0 would indicate to the UE that it should deactivate that SPS instance. In an accordance with the examples of this disclosure, the U-DCI may be different to an Activation DCI and Deactivation DCI in that the U-DCI may use the HPN field to point to an already activated SPS instance with a particular SPS index with a non-zero NDI value (e.g. NDI=1). Upon receiving the DCI with a non-zero NDI value, the UE knows to update the parameters for the activated SPS instance with the particular SPS instance in accordance with the parameters set out in the U-DCI. When using this format for the U-DCI, the U-DCI may use the same CS-RNTI as the Activation DCI and Deactivation DCI messages.

While the U-DCI may indicate all of the parameters of the SPS instance, only a subset of the parameters may be changed by a given U-DCI. That is, the U-DCI may change only a subset of the parameters of an SPS instance. Accordingly, the U-DCI may indicate values for all parameters of the SPS instance, where the unchanged values are included in the U-DCI and are identical to those included in the A-DCI, or the U-DCI may only include values for the changed parameters. That is, the U-DCI may contain only a subset of the information/parameters of the A-DCI. This reduces the amount of data transmitted as part of the U-DCI.

The U-DCI may in some examples include an update index which corresponds to a predefined set of parameters for an SPS instance. That is, a U-DCI may include a particular update index, where a UE uses the index to lookup a set of parameters in a predefined list or table of sets of parameters, and uses the set of parameters corresponding to the update index for the SPS instance. Accordingly, the size of the U-DCI can be kept small, while still providing the UE with the updated parameters of the SPS instance. An example is shown in Table 1 below, where a lookup table contains 8 update indices (i.e. requiring only 3 bits in the U-DCI), and where each update index corresponds to a set of parameters (e.g. MCS, TDRA and FDRA). The U-DCI indicates an update index, e.g. update index=4, and the UE looks up the update index in the table and apply values of MCS=7, 6 OFDM symbols and 30 RBs to the SPS instance.

TABLE 1
Example lookup table for PDSCH parameters

| Update Index | MCS | TDRA | FDRA |
|---|---|---|---|
| 0 | 3 | 5 OFDM Symbols | 10 RBs |
| 1 | 3 | 10 OFDM Symbols | 10 RBs |
| 2 | 5 | 5 OFDM Symbols | 20 RBs |
| 3 | 5 | 10 OFDM Symbols | 20 RBs |
| 4 | 7 | 6 OFDM Symbols | 30 RBs |
| 5 | 7 | 12 OFDM Symbols | 30 RBs |
| 6 | 9 | 6 OFDM Symbols | 40 RBs |
| 7 | 9 | 12 OFDM Symbols | 40 RBs |

It should be appreciated that parameters other than MCS, TDRA and FDRA can be used in a lookup table. Furthermore, in some examples, a U-DCI may indicate an offset index, rather than an update index, which increases or decreases the value of the update index maintained by the UE. For example, if the current update index is 5 (as per Table 1), this corresponds to settings MCS=7, 12 OFDM Symbols and 30 RBs, and if the U-DCI indicates an offset index of −2, the UE decreases its update index by 2, i.e. from 5 to 3. Accordingly, the UE then uses the parameters corresponding to update index 3 in Table 1, i.e. MCS=5, 10 OFDM Symbols and 20 RBs.

In some examples, a default index of the lookup table is assumed upon receipt of an Activation DCI. This recognizes that the update index may not be included in an Activation DCI and so a default index is assumed for the case where the U-DCI indicates an offset index. That is, an Activation DCI does not need to use a set of parameters included in the lookup table and may use substantially any parameters. Accordingly, if a subsequent U-DCI is received including an offset index, a default index may be used in order for the offset index to be correctly interpreted. For example, the default Index may be 1 (corresponding to MCS=3, 10 OFDM Symbols and 10 RBs in Table 1), but the A-DCI may activate an SPS instance with MCS=5, 7 OFDM Symbols and 15 RBs, which does not correspond with any update indices in the lookup table. Accordingly, if a U-DCI sends includes an offset index of 2, the UE may increase its value of the update index from the default value of 1 to a value of 3 and use the corresponding parameters for index=3 in the lookup table (MCS=5, 10 OFDM Symbols and 20 RBs in the example of Table 1). Another further U-DCI may indicate offset index of 1 and the UE will then use the update index=3+1=4 in the look up table (MCS=7, 6 OFDM Symbols and 30 RBs in the example of Table 1). That is, the default index is a starting point for the first U-DCI indication of an offset Index. Indicating only an update index of a lookup table requires only a small number of bits, which may in some cases be particularly advantageous for a GC-DCI based U-DCI, as updates must be sent to multiple UEs.

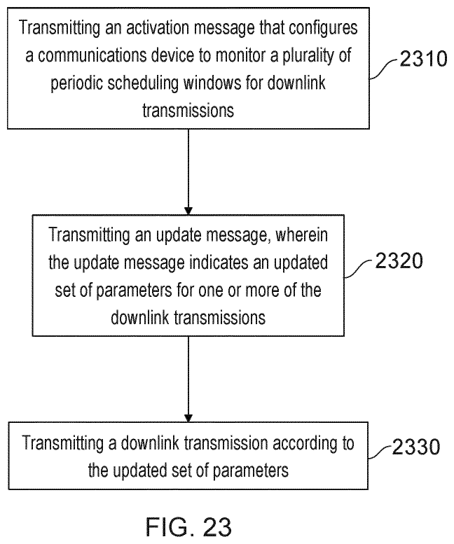

FIG. 23 illustrates a flow diagram of an example method for an infrastructure equipment according to the present disclosure. The method includes step 2310 of transmitting an activation message that configures a communications device to monitor a plurality of periodic scheduling windows for downlink transmissions. The activation message indicates an initial set of parameters for the downlink transmissions. The method then includes the step 2320 of Transmitting an update message, wherein the update message indicates an updated set of parameters for one or more of the downlink transmissions. The method includes the further step 2330 of transmitting a downlink transmission according to the updated set of parameters.

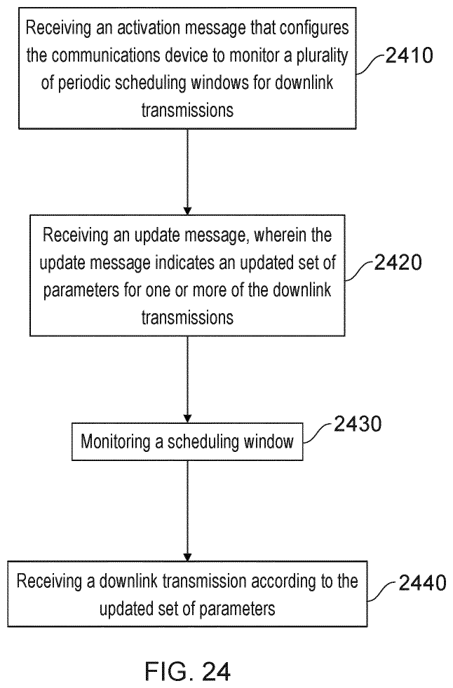

FIG. 24 illustrates a flow diagram of an example method for a communications device according to the present disclosure. The method includes a step 2410 of receiving an activation message that configures the communications device to monitor a plurality of periodic scheduling windows for downlink transmissions. The activation message indicates an initial set of parameters for the downlink transmissions. The method then includes step 2420 of receiving an update message, wherein the update message indicates an updated set of parameters for one or more of the downlink transmissions. The method proceeds to step 2430 of monitoring a scheduling window and further includes step 2440 of receiving a downlink transmission according to the updated set of parameters.

Accordingly, from one perspective there has been described methods and apparatus for updating parameters for scheduled downlink transmissions. A method for an infrastructure equipment, includes transmitting, to a communications device, an activation message (e.g. an activation DCI), wherein the activation message configures the communications device to monitor a plurality of periodic scheduling windows (e.g. an plurality of SPS occasions) for downlink transmissions (e.g. a PDSCH), wherein the activation message indicates an initial set of parameters for the downlink transmissions (e.g. a transport block size). The method includes transmitting, to the communications device, an update message (e.g. via downlink control information), wherein the update message indicates an updated set of parameters for one or more of the downlink transmissions (without deactivating the SPS instance) and transmitting, to the communications device and during a scheduling window of the plurality of periodic scheduling windows, a downlink transmission according to the updated set of parameters.

The following numbered clauses provide further example aspects and features of the present technique:

1. A method for an infrastructure equipment, the method comprising:
transmitting, to a communications device, an activation message, wherein the activation message configures the communications device to monitor a plurality of periodic scheduling windows for downlink transmissions, wherein the activation message indicates an initial set of parameters for the downlink transmissions;
transmitting, to the communications device, an update message, wherein the update message indicates an updated set of parameters for one or more of the downlink transmissions;
transmitting, to the communications device and during a scheduling window of the plurality of periodic scheduling windows, a downlink transmission according to the updated set of parameters.

2. The method according to clause 1, wherein the update message is embedded within a payload of the downlink transmission.

3. The method according to clause 2, wherein the update message is encoded differently to payload data of the downlink transmission.

4. The method according to clause 2 or clause 3, wherein the update message is modulated differently to payload data of the downlink transmission.

5. The method according to any of clauses 2-4, wherein the update message mapped to predetermined frequency resources of the downlink transmission.

6. The method according to any of clauses 2-5, wherein the update message is distributed across a plurality of time resources within a payload of the downlink transmission.

7. The method according to any of clauses 2-6, wherein the update message is included at a beginning of a payload of the downlink transmission.

8. The method according to any of clauses 2-7, wherein the downlink transmission includes an update indicator configured to indicate the presence of the update message within the downlink transmission.

9. The method according to clause 1, wherein the update message is transmitted prior to the downlink transmission.

10. The method according to clause 9, wherein the update message is transmitted in a control channel transmission.

11. The method according to clause 9 or clause 10, wherein the updated set of parameters indicate an earlier timing for the scheduling window.

12. The method according to any of clauses 9-11, wherein the update message is transmitted in a predetermined update window prior to the scheduling window.

13. The method according to any of clauses 9-12, wherein the update message is transmitted to a plurality of communications devices.

14. The method according to clause 1, wherein the update message is included within a demodulation reference signal of the downlink transmission.

15. The method according to any preceding clause, wherein the update message instructs the communications device to monitor for a further downlink transmission scheduled after the downlink transmission, and
wherein the method further comprises transmitting, to the communications device, the further downlink transmission.

16. The method according to clause 15, wherein a payload of the downlink transmission includes only the update message.

17. The method according to any preceding clause, wherein the set of parameters indicate a change to one or more of:
a transport block size of the downlink transmissions;
a frequency allocation of the downlink transmissions;
a timing of the downlink transmissions; and
a modulation and/or coding rate of the downlink transmissions.

18. The method according to any preceding clause, wherein the update message indicates that the updated set of parameters is indefinitely applicable to subsequent downlink transmissions.

19 The method according to any of clauses 1-17, wherein the update message indicates that the updated set of parameters is applicable to a fixed number of downlink transmissions.

20. The method according to any preceding clause, further comprising receiving, from the communications device, an acknowledgement that the communications device received the update message.

21. The method according to any preceding clause, wherein the update message has a same format as the activation message.

22. The method according to any preceding clause, wherein the update message includes a subset of the set of parameters, wherein each parameter of the subset is updated in the updated set of parameters.

23. The method according to any of clauses 1-20, wherein the updated set of parameters are predetermined, and wherein the update message includes an index corresponding to the updated set of parameters.

24. The method according to any of clauses 1-20, wherein the update message includes an offset value indicating a change to an index corresponding to a particular set of parameters.

25. The method according to any preceding clause, wherein a cyclic redundancy check of the update message is scrambled with a unique radio network temporary identifier.

26. The method according to any preceding clause, further comprising:
transmitting, to the communications device prior to the update message, and during a scheduling window of the plurality of periodic scheduling windows, a downlink transmission according to the initial set of parameters.

27 An infrastructure equipment comprising:
a transceiver configured to transmit signals to and/or to receive signals from communications device via a wireless radio interface provided by the infrastructure equipment, and
a controller configured in combination with the transceiver to:
   transmit, to a communications device, an activation message, wherein the activation message configures the communications device to monitor a plurality of periodic scheduling windows for downlink transmissions, wherein the activation message indicates an initial set of parameters for the downlink transmissions;
   transmit, to the communications device, an update message, wherein the update DCI messages indicates an updated set of parameters for one or more of the downlink transmissions;
   transmit, to the communications device and during a scheduling window of the plurality of periodic scheduling windows, a downlink transmission according to the updated set of parameters.

28. Circuitry for a communication, the circuitry comprising:
transceiver circuitry configured to transmit signals to and/or to receive signals from communications device via a wireless radio interface provided by the infrastructure equipment, and
controller circuitry configured in combination with the transceiver circuitry to:
   transmit, to a communications device, an activation message, wherein the activation message configures the communications device to monitor a plurality of periodic scheduling windows for downlink transmissions, wherein the activation message indicates an initial set of parameters for the downlink transmissions;
   transmit, to the communications device, an update message, wherein the update DCI messages indicates an updated set of parameters for one or more of the downlink transmissions;
   transmit, to the communications device and during a scheduling window of the plurality of periodic scheduling windows, a downlink transmission according to the updated set of parameters.

29. A method for a communications device, the method comprising:
receiving, from an infrastructure equipment, an activation message, wherein the activation message configures the communications device to monitor a plurality of periodic scheduling windows for downlink transmissions, wherein the activation message indicates an initial set of parameters for the downlink transmissions;
receiving, from the infrastructure equipment, an update message, wherein the update message indicates an updated set of parameters for one or more of the downlink transmissions;
monitoring, a scheduling window of the plurality of periodic scheduling windows; and
receiving, from the infrastructure equipment and during the scheduling window, a downlink transmission according to the updated set of parameters.

30. The method of clause 29, wherein the update message is embedded within a payload of the downlink transmission.

31. The method according to clause 30, wherein the update message is encoded differently to payload data of the downlink transmission.

32. The method according to clause 30 or clause 31, wherein the update message is modulated differently to payload data of the downlink transmission.

33. The method according to any of clauses 30-32, wherein the update message mapped to predetermined frequency resources of the downlink transmission.

34. The method according to any of clauses 30-33, wherein the update message is distributed across a plurality of time resources within a payload of the downlink transmission.

35. The method according to any of clauses 30-34, wherein the update message is included at a beginning of a payload of the downlink transmission.

36. The method according to any of clauses 30-35, wherein the downlink transmission includes an update indicator configured to indicate the presence of the update message within the downlink transmission.

37. The method according to clause 29, wherein the update message is transmitted prior to the downlink transmission.

38. The method according to clause 37, wherein the update message is transmitted in a control channel transmission.

39. The method according to clause 37 or clause 38, wherein the updated set of parameters indicate an earlier timing for the scheduling window.

40. The method according to any of clauses 37-39, wherein the update message is transmitted in a predetermined update window prior to the scheduling window.

41. The method according to any of clauses 37-40, wherein the update message is transmitted to a plurality of communications devices.

42. The method according to clause 29, wherein the update message is included within a demodulation reference signal of the downlink transmission.

43. The method according to any of clauses 29-42, wherein the update message instructs the communications device to monitor for a further downlink transmission scheduled after the downlink transmission, and
wherein the method further comprises transmitting, to the communications device, the further downlink transmission.

44. The method according to clause 43, wherein a payload of the downlink transmission includes only the update message.

45. The method according to any of clauses 29-44, wherein the set of parameters indicate a change to one or more of:
a transport block size of the downlink transmissions;
a frequency allocation of the downlink transmissions;
a timing of the downlink transmissions; and
a modulation and/or coding rate of the downlink transmissions.

46 The method according to any of clauses 29-45, wherein the update message indicates that the updated set of parameters is indefinitely applicable to subsequent downlink transmissions.

47. The method according to any of clauses 29-46, wherein the update message indicates that the updated set of parameters is applicable to a fixed number of downlink transmissions.

48. The method according to any of clauses 29-47, further comprising receiving, from the communications device, an acknowledgement that the communications device received the update message.

49. The method according to any of clauses 29-48, wherein the update message has a same format as the activation message.

50. The method according to any of clauses 29-49, wherein the update message includes a subset of the set of parameters, wherein each parameter of the subset is updated in the updated set of parameters.

51. The method according to any of clauses 29-48, wherein the updated set of parameters are predetermined, and wherein the update message includes an index corresponding to the updated set of parameters.

52. The method according to any of clauses 29-48, wherein the update message includes an offset value indicating a change to an index corresponding to a particular set of parameters.

53. The method according to any of clauses 29-52, further comprising:
transmitting, to the communications device prior to the update message, and during a scheduling window of the plurality of periodic scheduling windows, a downlink transmission according to the initial set of parameters.

54. A communications device comprising:
a transceiver configured to transmit signals to and/or to receive signals from an infrastructure equipment of a wireless communications network via a wireless radio interface provided by the wireless communications network, and
a controller configured in combination with the transceiver to:
   receive, from an infrastructure equipment, an activation message, wherein the activation message configures the communications device to monitor a plurality of periodic scheduling windows for downlink transmissions, wherein the activation message indicates an initial set of parameters for the downlink transmissions;
   receive, from the infrastructure equipment, an update message, wherein the update message indicates an updated set of parameters for one or more of the downlink transmissions;
   monitor, a scheduling window of the plurality of periodic scheduling windows; and
   receive, from the infrastructure equipment and during the scheduling window, a downlink transmission according to the updated set of parameters.

55 Circuitry for a communications device comprising:
transceiver circuitry configured to transmit signals to and/or to receive signals from an infrastructure equipment of a wireless communications network via a wireless radio interface provided by the wireless communications network, and
controller circuitry configured in combination with the transceiver circuitry to:
   receive, from an infrastructure equipment, an activation message, wherein the activation message configures the communications device to monitor a plurality of periodic scheduling windows for downlink transmissions, wherein the activation message indicates an initial set of parameters for the downlink transmissions;
   receive, from the infrastructure equipment, an update message, wherein the update message indicates an updated set of parameters for one or more of the downlink transmissions;
   monitor, a scheduling window of the plurality of periodic scheduling windows; and
   receive, from the infrastructure equipment and during the scheduling window, a downlink transmission according to the updated set of parameters.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LTE for UMTS OFDMA and SC-FDMA based radio access”, John Wiley and Sons, 2009.
[2] RP-190726, “Physical layer enhancements for NR ultra-reliable and low latency communication (URLLC)”, Huawei, HiSilicon, RAN #83.
[3] RP-201310, “Revised WID: Enhanced Industrial Internet of Things (IoT) and ultra-reliable and low latency communication (URLLC) support for NR,” Nokia, Nokia Shanghai Bell, RAN #88e.
[4] European patent application number 20155210.6, “Intra-UE Multiplexing Indicator”.
[5] RP-213587, “Study on XR Enhancements for NR”, Nokia, RAN #94e

1. A method for an infrastructure equipment, the method comprising:
transmitting, to a communications device, an activation message, wherein the activation message configures the communications device to monitor a plurality of periodic scheduling windows for downlink transmissions, wherein the activation message indicates an initial set of parameters for the downlink transmissions;
transmitting, to the communications device, an update message, wherein the update message indicates an updated set of parameters for one or more of the downlink transmissions; and
transmitting, to the communications device and during a scheduling window of the plurality of periodic scheduling windows, a downlink transmission according to the updated set of parameters.

2. The method according to claim 1, wherein the update message is embedded within a payload of the downlink transmission.

3. The method according to claim 2, wherein the update message is encoded differently to payload data of the downlink transmission.

4. The method according to claim 2, wherein the update message is modulated differently to payload data of the downlink transmission.

5. The method according to claim 2, wherein the update message mapped to predetermined frequency resources of the downlink transmission.

6. The method according to claim 2, wherein the update message is distributed across a plurality of time resources within a payload of the downlink transmission.

7. The method according to claim 2, wherein the update message is included at a beginning of a payload of the downlink transmission.

8. The method according to claim 2, wherein the downlink transmission includes an update indicator configured to indicate the presence of the update message within the downlink transmission.

9. The method according to claim 1, wherein the update message is transmitted prior to the downlink transmission.

10. The method according to claim 9, wherein the update message is transmitted in a control channel transmission.

11. The method according to claim 9, wherein the updated set of parameters indicate an earlier timing for the scheduling window.

12. The method according to claim 9, wherein the update message is transmitted in a predetermined update window prior to the scheduling window.

13. The method according to claim 9, wherein the update message is transmitted to a plurality of communications devices.

14. The method according to claim 1, wherein the update message is included within a demodulation reference signal of the downlink transmission.

15. The method according to claim 1, wherein the update message instructs the communications device to monitor for a further downlink transmission scheduled after the downlink transmission, and
wherein the method further comprises transmitting, to the communications device, the further downlink transmission.

16. The method according to claim 15, wherein a payload of the downlink transmission includes only the update message.

17. The method according to claim 1, wherein the set of parameters indicate a change to one or more of:
a transport block size of the downlink transmissions;
a frequency allocation of the downlink transmissions;
a timing of the downlink transmissions; and
a modulation and/or coding rate of the downlink transmissions.

18. (canceled)

19. The method according to claim 1, wherein the update message indicates that the updated set of parameters is applicable to a fixed number of downlink transmissions.

20.-26. (canceled)

27. An infrastructure equipment comprising:
a transceiver configured to transmit signals to and/or to receive signals from communications device via a wireless radio interface provided by the infrastructure equipment, and
a controller configured in combination with the transceiver to:
transmit, to a communications device, an activation message, wherein the activation message configures the communications device to monitor a plurality of periodic scheduling windows for downlink transmissions, wherein the activation message indicates an initial set of parameters for the downlink transmissions;
transmit, to the communications device, an update message, wherein the update DCI messages indicates an updated set of parameters for one or more of the downlink transmissions; and
transmit, to the communications device and during a scheduling window of the plurality of periodic scheduling windows, a downlink transmission according to the updated set of parameters.

28.-53. (canceled)

54. A communications device comprising:
a transceiver configured to transmit signals to and/or to receive signals from an infrastructure equipment of a wireless communications network via a wireless radio interface provided by the wireless communications network, and
a controller configured in combination with the transceiver to:
receive, from an infrastructure equipment, an activation message, wherein the activation message configures the communications device to monitor a plurality of periodic scheduling windows for downlink transmissions, wherein the activation message indicates an initial set of parameters for the downlink transmissions;
receive, from the infrastructure equipment, an update message, wherein the update message indicates an updated set of parameters for one or more of the downlink transmissions;
monitor, a scheduling window of the plurality of periodic scheduling windows; and
receive, from the infrastructure equipment and during the scheduling window, a downlink transmission according to the updated set of parameters.

55. (canceled)
